(19) United States
(12) Patent Application Publication
(10) Pub. No.: US 2023/0351049 A1
(43) Pub. Date: Nov. 2, 2023

(54) CERTIFICATION SYSTEM FOR ARTIFICIAL INTELLIGENCE MODEL

(71) Applicant: Taut AI, Inc., San Francisco, CA (US)

(72) Inventor: Thomas M. ANNAU, San Carlos, CA (US)

(73) Assignee: Taut AI, Inc., San Francisco, CA (US)

(21) Appl. No.: 17/734,009

(22) Filed: Apr. 30, 2022

(51) Int. Cl. G06F 21/64; G06F 21/62

(52) U.S. Cl. CPC G06F 21/64; G06F 21/6245; G06N 20/00

(57) ABSTRACT

The disclosure includes embodiments of a method for a certification system for an artificial intelligence (AI) model. According to some embodiments, the method includes analyzing the AI model to determine that the AI model is compliant with the set of metrics. The method includes certifying the AI model responsive to determining that the AI model is compliant with the set of metrics. The set of metrics includes verifying that at least one layer Z of the AI model is invertible. The method includes certifying the AI model responsive to determining that the AI model is compliant with the set of metrics. In some embodiments, if the AI model includes a plurality of layers Z and the set of metrics verify that each of the layers Z is invertible, then AI model is certified as an “invertible AI model.”

### BACKGROUND

The specification relates to a certification system for an artificial intelligence model.

The current state-of-the-art in Artificial Intelligence (AI) is referred to as Deep Learning (DL). DL is based on the mathematical framework of function approximation. Any problem solvable by DL must be stated as a prediction problem: given inputs “x”, predict outputs “y” using a function y=f(x; p) (where “f” is a function, “x” is the input to the function, “p” are the parameters of the function, and “y” is the output of the function). The function “f” is described by code and routines included in the AI model. The outputs can be specified as part of a supervised task, such as predicting human-labeled categories from the content of images, or a self-supervised task, such as predicting the next word in a sentence from the preceding text. The function “f” is typically complex and highly parameterized, with parameter counts in some cases extending into the millions and even billions. As such, the specific mechanism of current AI models built based on DL is often not discernable to human users of these AI models. In other words, a first fundamental problem with current AI models based on DL is that the human users know “what” these AI models do, but they do not know “how” these AI models do it. For example, a human user knows that a trained AI model is meant to perform a specific task, but the human operator does not understand precisely how the AI model performs this task or how the algorithm of the AI model should be changed to achieve specific modifications in the functionality of the AI model.

Instead, the human user must rely on experimenting with the functional form of the AI model until the output of the AI model better meets the expectations of the human user. For example, the human user can experiment with different functional forms of f(x; p), optimizing the values of “p” for each using a training set of (x, y) examples, to determine which optimized function minimizes the measured error between predictions f(x; p) and outputs “y” across all training example pairs. This “architecture search” is not strictly engineering, and more akin to random trial and error, since the details of the internal mechanism of the AI model (e.g., “how” the AI model does what it does) and the various computational layers of its algorithm are unknown, and unknowable due to their inherent complexity, to the human user of the AI model.

A second fundamental problem with current AI models based on DL is that every computation function performed by the AI model is determined by the utility of the computation to the particular prediction task of the AI model. Any aspect of the input to the AI model that is not necessary to accurately predict the output of the AI model can therefore be ignored by the code and routines of the AI model. Should the AI model be tasked to solve a new task, even a minor change such as the addition of a single new output category, the AI model may be ignoring critical information pertaining to the new task and require significant retraining to learn the discriminative features needed to solve the new task. Once retrained, the AI model may lose its ability to solve the original task, a problem known as “catastrophic forgetting.” Accordingly, current AI models based on DL are prone to catastrophic forgetting.

A third problem with current AI models based on DL is that any hidden bias in the training data used to train the AI model that predicts the output will be exploited by the AI model. For example, if all inputs to the AI model from an individual output category of “y” share one unique distinguishing feature in “x”, then detecting that feature is all that the function f(x; p) of the AI model needs to identify this category and it can ignore all other representational detail included in the input. If this correlation between feature and category is limited to the training data, this strategy will fail to generalize; if the function f(x; p)'s “plan A” does not work, it has no “plan B.”

To state all three problems succinctly, DL is very prone to overfitting and in ways that may not be comprehensible to or detectable by its human users. These problems pose a significant barrier to AI being an auditable, practical and robust technology.

### SUMMARY

Described herein are embodiments of a certification system for determining whether an AI model satisfies a set of thresholds for a set of metrics. An example list of the thresholds included in the set of thresholds is provided within the description of FIG. 6 below. Any AI model that is based on current DL algorithms (herein “traditional DL”) will not satisfy the complete set of thresholds necessary to be certified by the certification system. Accordingly, described herein is a framework for certifying AI models that are not based on traditional DL.

In some embodiments, each metric has one or more thresholds that correspond to that metric, and satisfaction of the one or more thresholds that correspond to the metric is termed as “satisfying the metric.” Accordingly, “satisfying the interpretability metric” means satisfying the one or more metrics that correspond to the interpretability metric.

In some embodiments, the set of metrics are referred to as “RISE metrics” because they measure the Robustness, Interpretability, Security, and Efficiency (RISE) of an AI model. For example, in some embodiments the certification system is operable to compare one or more of the operation, the performance, and the architecture of an AI model against a set of thresholds for the RISE metrics to determine whether the AI model has one or more of the following RISE characteristics: (1) robustness; (2) interpretability; (3) security; and (4) efficiency. These RISE characteristics, and the thresholds used by the certification system to measure them, are described in more detail below.

Accordingly, an example benefit of the certification system is that the certification system encourages AI model developers to generate AI models that will satisfy the set of thresholds for one or more the RISE metrics so that these AI models have the RISE characteristics. For example, the certification system is associated with a digital store that publishes AI models for purchase or license. The digital store will not publish an AI model for purchase or license unless the AI model is certified by the certification system. In some embodiments, the certification system will not certify an AI model unless each of the RISE metrics is satisfied. Accordingly, the certification system encourages AI developers to create AI models having the RISE characteristics since their AI models will not be monetizable via the digital store unless they have these RISE characteristics.

In some embodiments, an AI model that satisfies one or more sets of thresholds is compliant with a set of RISE metrics and therefore eligible to be certified by the certification system. The thresholds are those which correspond to the set of RISE metrics. In some embodiments, the certification system includes code and routines that are operable to determine if one or more of the operation, performance, and architecture of an AI model satisfies the set of thresholds for the RISE metrics, and if the determination is positive, then the certification system determines that the AI model is eligible to be certified by the certification system. In some embodiments, the AI model is not certified by the certification system unless a fee is paid to the operator of the certification system or the digital store. An AI model that does not satisfy the set of thresholds for the RISE metrics is non-compliant with the RISE metrics, and therefore ineligible to be certified by the certification system.

In some embodiments, an AI model that satisfies the one or more sets of thresholds for the RISE metrics is issued a certification by the certification system.

Example benefits of the certification system are now described according to some embodiments. In some embodiments, the certification system is operable to determine whether one or more of the operation, performance, and architecture of an AI model satisfies one or more sets of thresholds for one or more RISE metrics. AI models whose architecture, performance and operation satisfy these thresholds are known to provide the benefits of being easier to: build; train; debug; integrate into other software; monitor; audit; and iteratively improve. Accordingly, the certification system is operable to certify that AI models satisfy the RISE metrics and therefore provide these benefits. Accordingly, operation of the certification system beneficially improves the operation, performance, and architecture of AI models. Operation of the certification system also improves the performance of processor-based computer systems that include AI models that have by certified by the certification system.

For example, these computer systems perform better because they include AI models that have been certified by the certification system, and this is not possible unless the certification system is operating. A similar benefit is provided to any system that incorporates AI models that have been certified by the certification system or is built based on the operation of these AI models. Accordingly, the certification system beneficially improves the performance of AI models and any processor-based computing system that includes or is built based on these AI models.

The RISE metrics, the sets of thresholds that correspond to each RISE metric, and the operation of the certification system are described in more detail below.

In some embodiments, the certification system is configured to provide a digital store. Digital store data includes code and routines that are operable, when executed by a processor, to cause the processor to provide a digital store. In some embodiments, the digital store publishes AI models that have been certified by the certification as possessing the RISE characteristics. Customers browse the digital store for AI model that are eligible to purchase or license. The digital store includes functionality whereby customers are able to purchase or license an AI model which has been certified by the certification system. Customers are encouraged to purchase or license AI models from the digital store since every AI model available within the digital store is certified to possess the RISE characteristics. Accordingly, the AI models available from the digital store are known to provide the benefits of being easier to: build; debug; integrate into other software; monitor; audit; and iteratively improve.

Customers and vendors use the digital store for various purposes. For example, a vendor includes a developer of AI models. The vendor is able to submit an AI model they have developed (a “submitted AI model”) to the digital store and request that it be certified by the certification system. They may only want to purchase or license the certification offered by the certification system, or they may want the certification as well as the opportunity to monetize their AI model within the digital store.

In some embodiments, the certification system tests whether the operation and architecture of the submitted AI model satisfies the RISE metrics. If the certification system determines that the submitted AI model does not satisfy the RISE metrics, then the submitted AI model is not certified and will not be available for customers to license via the digital store front. If the certification system determines that the submitted AI model satisfies the RISE metrics, the submitted AI model is available for customers to license via the digital store front.

In some embodiments, the vendor pays a fee to the operator of the digital store in exchange for the certification system to analyze the submitted AI model to determine if it satisfies the RISE metrics. In some embodiments, the digital store includes functionality whereby a vendor is able to purchase a license from the digital store to advertise that the submitted AI model is certified by the certification system, or the entity that operates the certification system, as compliant with the RISE metrics. In some embodiments, the digital store includes functionality whereby a vendor is able to purchase a license from the digital store to use a protected digital indication that the submitted AI model is certified as having satisfied the RISE metrics. A protected digital indication includes, for example, one or more of the following: a trademarked image; a trademarked set of words; a proprietary mark; a digital seal; a non-fungible token; or some other proprietary indication that a particular AI model has been certified by the certification system and found to satisfy the RISE metrics and/or possess the RISE characteristics.

In this way the certification system is beneficially operable to provide a transparent and efficient marketplace for consumers to purchase AI models that have the qualities necessary to satisfy the RISE metrics.

The digital store and certifications issued by the certification system are described in more detail below.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for providing an invertible artificial intelligence (AI) model. The method also includes initiating a layer Z of the invertible AI model with a first digital data set X; causing a first execution, by a processor, of the layer Z to be initiated by the first digital data set X thereby causing the layer Z to output a second digital data set Y; initiating the layer Z of the AI model with the second digital data set Y; and causing a second execution of the layer Z, which is an inversion of the first execution, to be initiated by the second digital data set Y thereby causing the layer Z to output a third digital data set X_{z} which is an idealized representation of the first digital data set X that is understandable by a human operator to be an idealized representation of the first digital data set X. Other embodiments of this aspect include corresponding computer systems, apparatus, and computer programs recorded on one or more computer storage devices, each configured to perform the actions of the methods.

Implementations may include one or more of the following features. The method where the idealized representation is configured to allow the human operator to see how the layer Z is idealizing the first data set X. The idealized representation is configured to allow the human operator to see if the layer Z is making an interpretation error of the first data set X. The interpretation error includes a semantic miscategorization error. The second execution of the layer Z is initiated with a subset of the second digital data set Y and the third digital data set X_{z} is configured to allow the human to understand what part of the first digital data set X is represented by the subset of Y used to initiate the layer Z for the second execution. In some embodiments, the subset is as small as a single bit of data of the second digital data set Y. In some embodiments, the second digital data set Y informs a human operator when the first digital data set X is not represented by any similar set of items within a training data set used to train the invertible AI model. The invertible AI model satisfies a threshold that measures how successfully the AI model informs the human operator about when the first digital data set X is not represented by any similar set of items within a training data set used to train the invertible AI model. In some embodiments, the second digital data set Y includes an element known as the “unfamiliar data indicator” or UDI that informs a human operator when the first digital data set X is not represented by any similar set of items within a training data set used to train the invertible AI model. For example, the second digital data set Y includes an indication (e.g., a UDI) that the layer Z is unable to semantically categorize the first digital data set X because the first digital data set X is not represented by any similar set of items within a training data set used to train the invertible AI model. The layer Z is invertible because the third digital data set X_{z} is the idealized representation of the first digital data set X that is understandable by the human to represent the first digital data set X. In some embodiments, the invertible AI model includes a plurality of layers and each of the layers is invertible. The method is modified to determine a functionality of the layer Z, the modifications to the method including: the initiating of the layer Z with the first digital data set X does not occur; the first execution does not occur; the layer Z includes a set of units U which includes a code set; the units U are configured invertibly (see, e.g., FIGS. 7 and 8 collectively) with a forward computational direction (see, e.g., FIG. 7 individually) and a reverse computational direction (see, e.g., FIG. 8 individually), where being configured invertibly includes the units U being operable to (1) receive in the forward computational direction the first digital data set X as inputs to the units U to generate the second digital data set Y as a forward output of the code set, the second digital data set Y including a subset Yₛ that is a specific output of a selected unit Us from the set of units U and (2) receive in the reverse computational direction the second digital data set Y as inputs to the units U to generate the first digital data set X as a reverse output of the units U, the reverse output including a subset Xₛ of the first digital data set X that corresponds to the subset Yₛ and was outputted by the selected unit Us in the reverse computational direction; the subset Yₛ corresponding to the selected unit Us is set to an active value and other subsets of Y are set to an inactive value; and the second execution occurs in the reverse computational direction to generate the subset Xₛ so that the human can interpret the functionality of the selected unit Us in a context of the first digital data set X. The invertible AI model includes a plurality of layers Zₚ. The layers Zₚ included in the plurality are communicatively coupled in a series so that the layers Zₚ receive, as an input, the output of a preceding layer in the series. The plurality of layers Zₚ are invertibly configured so that the first digital data set X is operable to be passed through the plurality of layers Zₚ and the functionality of any of the layers Z included in the plurality is determinable using at least two applications of the method. Implementations of the described techniques may include hardware, a method or process, or computer software on a computer-accessible medium.

In some embodiments, the AI model outputs the third digital data set X_{Z} after passing X through multiple layers then inverting them all to output the idealized representation that multiple layers produce.

One general aspect includes a method for certifying that an artificial intelligence (AI) model is compliant with a set of metrics. The method also includes analyzing the AI model to determine that the AI model is compliant with the set of metrics; and certifying the AI model responsive to determining that the AI model is compliant with the set of metrics, and where the set of metrics includes verifying that at least one layer Z of the AI model is invertible and the AI model is certified responsive to determining that the AI model is compliant with the set of metrics. Other embodiments of this aspect include corresponding computer systems, apparatus, and computer programs recorded on one or more computer storage devices, each configured to perform the actions of the methods.

Implementations may include one or more of the following features. The method where the set of metrics includes verifying that each layer Z of the AI model is invertible, where the AI model includes a plurality of layers Zₚ. The set of metrics further includes verifying an inference accuracy of the AI model by determining that execution of the AI model satisfies an accuracy threshold. The set of metrics further includes verifying an adaptability of the AI model by determining that execution of the AI model satisfies an adaptability threshold. The set of metrics further includes verifying an open set recognition of the AI model by determining that execution the AI model is able to identify when an input to the AI model is not represented by any similar items within a training data set used to train the AI model. The set of metrics further includes verifying a runtime learning ability of the AI model by determining that the AI model is able to learn new data categories in an unsupervised manner sufficient to satisfy a runtime learning threshold. The set of metrics further includes verifying that the AI model is sufficiently resistant to an adversarial attack by determining that execution of the AI model satisfies a threshold for resistance to the adversarial attack. The set of metrics further includes verifying that execution of the AI model is sufficiently resistant to leaking private information to satisfy a threshold for privacy. The set of metrics further includes verifying that the AI model is sufficiently invertible to create a secured log that satisfies a threshold for its security. The set of metrics further includes verifying an efficiency of the AI model by determining that execution the AI model satisfies one or more thresholds for efficiency. The one or more thresholds for efficiency are selected from a group that includes: a training cost threshold; an incremental training cost threshold; an inference cost threshold; and a memory footprint threshold. The method may include issuing an indication of the certification. The method may include providing a proof of the certification that is issued by an electronic store. The method may include completing a financial transaction with an electronic store to license an indication of the certification. The method may include publishing the AI model in an electronic store. A price of licensing the AI model from the electronic store is dependent at least in part on a performance of the AI model relative to a metric. The method may include unpublishing the AI model from an electronic store responsive to determining that the AI model no longer satisfies the set of metrics. The method may include completing a financial transaction to license the AI model via an electronic store. The method may include issuing a certification that the AI model is validated as being compliant with the set of metrics. Implementations of the described techniques may include hardware, a method or process, or computer software on a computer-accessible medium.

One general aspect includes a system for verifying that an artificial intelligence (AI) model is compliant with a set of metrics. The system also includes a processor; a non-transitory memory that is communicatively coupled to the processor, where the non-transitory memory stores computer executable code that is operable, when executed by the processor, to cause the processor to execute operations including: analyzing the AI model to determine that the AI model is compliant with the set of metrics; and publishing the AI model responsive to determining that the AI model is compliant with the set of metrics. The set of metrics includes verifying that at least one layer Z of the AI model is invertible. Other embodiments of this aspect include corresponding computer systems, apparatus, and computer programs recorded on one or more computer storage devices, each configured to perform the actions of the methods.

One general aspect includes a computer program product including computer code stored on a non-transitory memory that is operable, when executed by a computer, to cause the computer to execute operations including: analyzing the AI model to determine that the AI model is compliant with a set of metrics; and publishing the AI model responsive to determining that the AI model is compliant with the set of metrics. The set of metrics includes verifying that at least one layer Z of the AI model is invertible. Other embodiments of this aspect include corresponding computer systems, apparatus, and computer programs recorded on one or more computer storage devices, each configured to perform the actions of the methods.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an operating environment for a certification system according to some embodiments.

FIG. 2 is a block diagram illustrating an example computer system including a certification system according to some embodiments.

FIG. 3 is a flowchart of an example method for inverting the operation of an AI model to provide interpretability about the functionality of one or more layers of the AI model according to some embodiments.

FIG. 4 is a flowchart of an example method for determining whether an AI model satisfies a set of metrics according to some embodiments.

FIG. 5 is a block diagram illustrating a first digital data set X, a second digital data set Y, and a third digital data set X_{z} according to some embodiments.

FIG. 6 is a block diagram illustrating the computational units of an AI model according to some embodiments.

FIG. 7 is a block diagram illustrating a forward computational direction of an operation of a layer of an AI model according to some embodiments.

FIG. 8 is a block diagram illustrating a reverse computational direction of an operation of a layer of an AI model according to some embodiments.

FIG. 9 is a block diagram illustrating a forward computational direction of an operation of a plurality of layers of an AI model according to some embodiments.

FIG. 10 is a block diagram illustrating a reverse computational direction of an operation of a plurality of layers of an AI model according to some embodiments.

### DETAILED DESCRIPTION

Described herein are embodiments of a certification system. The functionality of the certification system is now introduced according to some embodiments.

In some embodiments, an Artificial Intelligence (AI) model includes code and routines that perform two computational steps. The first computational step is to receive an input and produce an output estimating information not explicitly present in the input but derivable from the input by the code and routines of the AI model. Producing an output estimating information not explicitly present in an input but derivable from the input includes one or more of the following computational functions: (a) enhancement of the input (e.g., clear speech reconstructed from a noisy audio recording); (b) imputation of missing input (e.g., filling in a missing or obscured section of an image); (c) prediction of future input or other digital data (e.g., predicting the next value in a time series); (d) summarization or labeling of the input (e.g., image categorization); (e) estimation, retrieval and/or identification of requested information and/or related information (e.g., estimating a house price based on size, location, condition, etc.); (f) any derivative of the computational functions described above; and (g) any combination of the computational functions described above. The examples described above for these computational functions are intended to be illustrative and not limiting.

The second computational step performed by the code and routines of an AI model is to compute its output based on a set of parameters whose values are learned by the AI model analyzing examples from a set of training data either (1) in an unsupervised manner, (2) a self-supervised manner, or (3) in a supervised manner

When an AI model learns the set of parameters in either an unsupervised manner or a self-supervised manner, this means that only training data is provided to the AI model during a learning stage and this training data does not include any labels which are added by a human operator to enhance the learning of the AI model. Example computational functions that may be provided by an AI model trained in an unsupervised or self-supervised manner include, for example, one or more of the following computational functions: (a) filtering and/or enhancement of the input; (b) imputation of missing input; (c) prediction of future input; (d) any derivative of the computational functions described above; and (f) any combination of the computational functions described above. The examples described above for these computational functions are intended to be illustrative and not limiting

When an AI model learns the set of parameters in supervised manner, this means that the training data provided to the AI model during the learning stage includes labels which are added by the human operator to enhance the learning of the AI model. Example computational functions that may be provided by an AI model trained in an unsupervised or self-supervised manner include, for example, one or more of the following computational functions: (a) summarization or labeling of the input; (b) estimation, retrieval, and/or identification of related information; (c) any derivative of the computational functions described above; and (d) any combination of the computational functions described above. The examples described above for these computational functions are intended to be illustrative and not limiting.

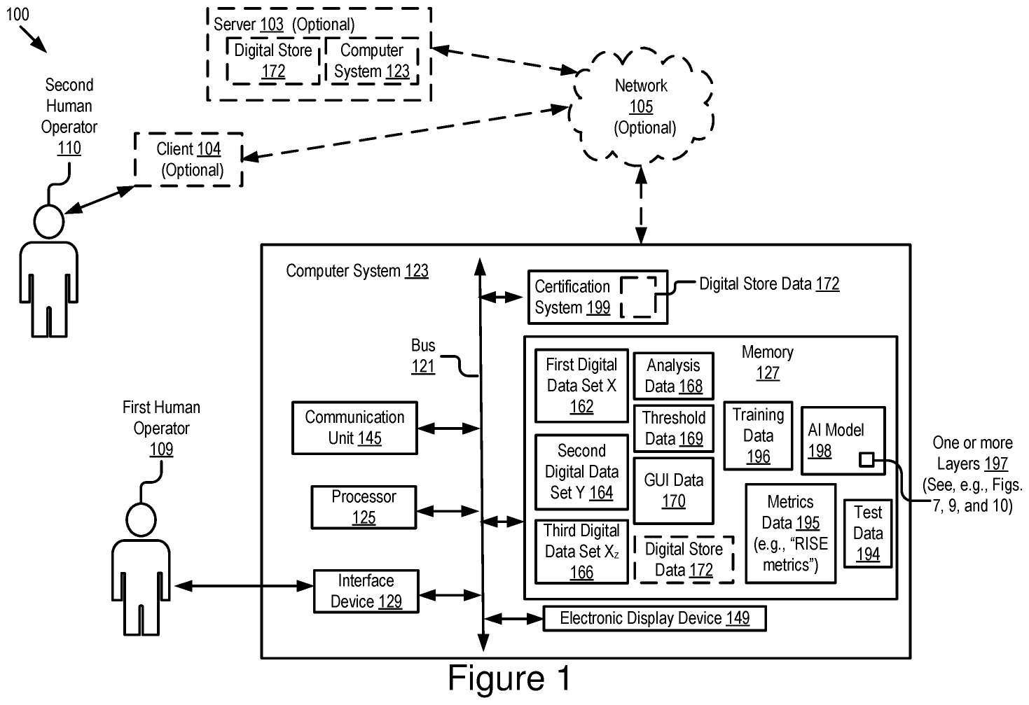

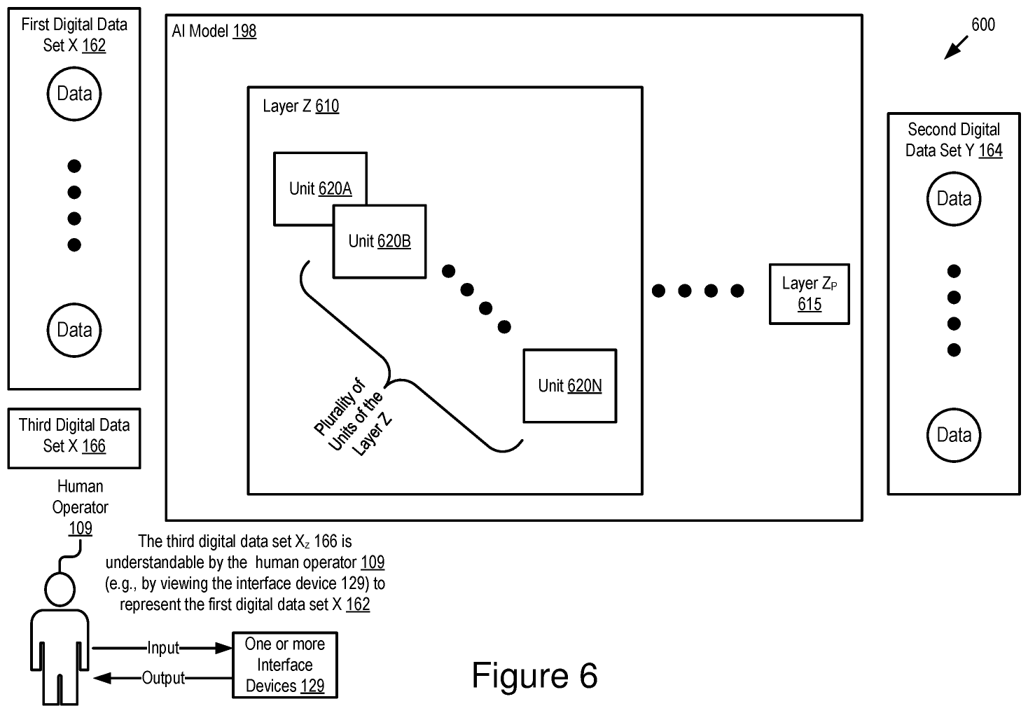

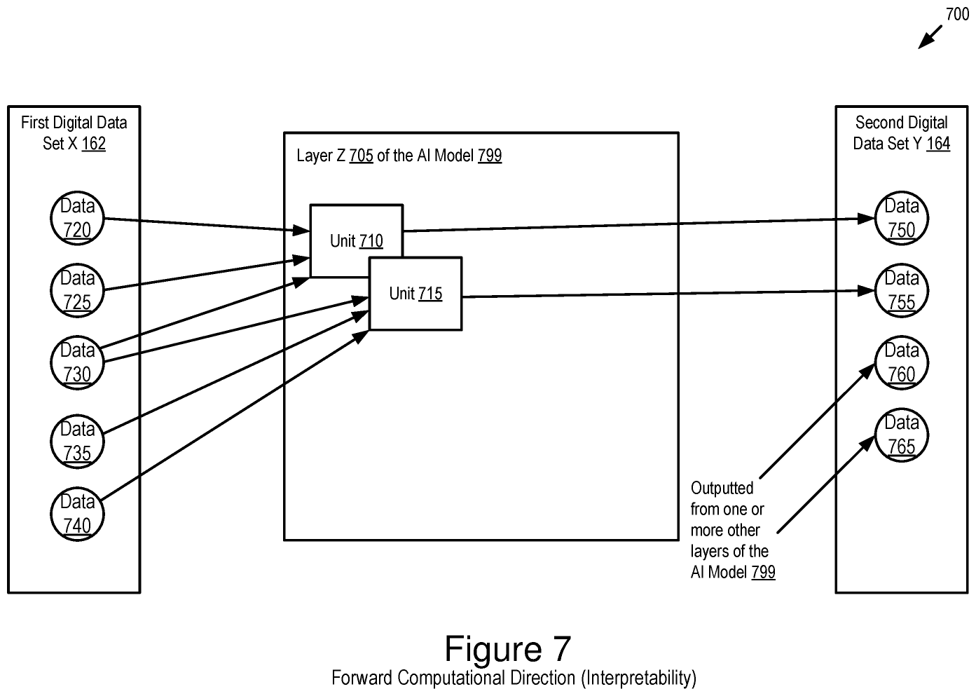

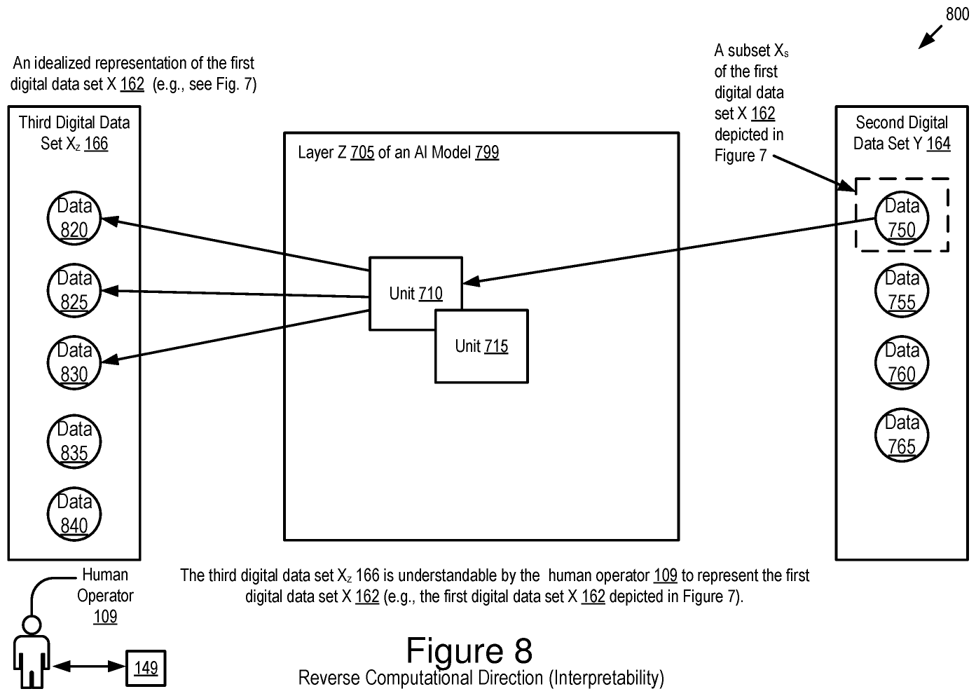

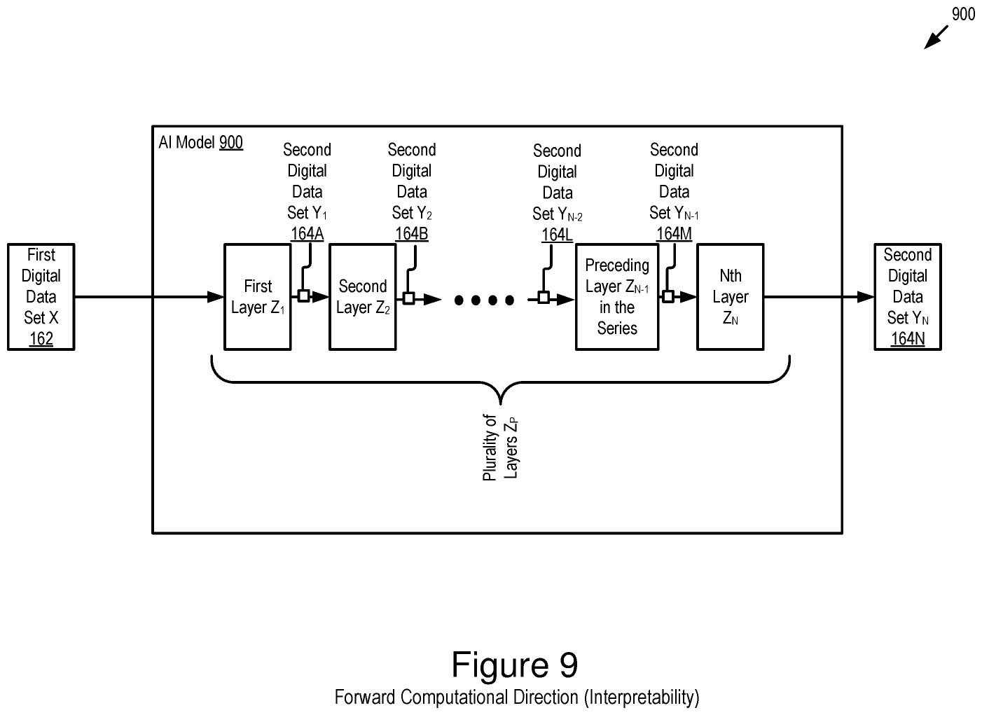

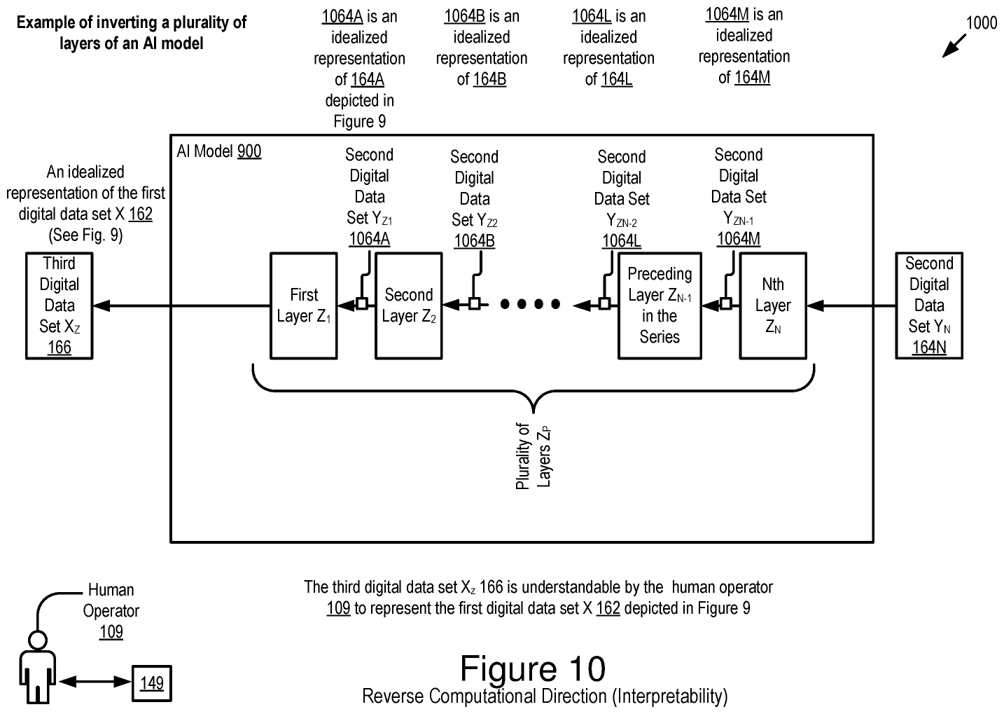

An example of the AI model according to some embodiments includes the AI model 198 depicted in FIGS. 1 and 6; AI model 799 depicted in FIGS. 7 and 8; and AI model 900 depicted in FIGS. 9 and 10.

Existing approaches to AI rely on DL. DL has proven to be a flawed, and for some, undesirable approach to AI. In some embodiments, any AI model that relies on DL is not compliant with the RISE metrics. In some embodiments, any AI models that relies on DL is unlikely to be compliant with the RISE metrics (e.g., because such AI models are inherently not interpretable when deployed for most real-world applications), but not specifically excluded from compliance with the RISE metrics.

In some embodiments, non-compliance with the RISE metrics means that one or more of the operation, performance, and architecture of the AI model did not satisfy at least one of the RISE metrics. In some embodiments, compliance with the RISE metrics means that one or more of the operation, performance, and architecture of the AI model satisfy one or more of the RISE metrics. In some embodiments, compliance with the RISE metrics means that one or more of the operation, performance, and architecture of the AI model satisfy each of the RISE metrics.

One example problem with DL is that AI models that rely on DL are not interpretable. Interpretability means that a human operator is able to analyze the input and the output of individual layers of an AI model and understand the purpose of the individual layers that processed its input. A layer of an AI model includes a functional unit of the code and routines of the AI model that perform a specific set of tasks or sub-tasks. Thus, an AI model that is interpretable is one in which a human operator is able to analyze the input and the output of individual layers of the AI model and understand how the individual layers processed its input to generate its output (e.g., the specific inputs and the specific outputs of each specific layer of the AI model).

In some embodiments, the certification system described herein determines whether an AI model is interpretable by determining whether the output of each layer of the AI model is invertible. In general, an AI model that is invertible on a layer-by-layer basis is also interpretable provided that the inverted output (e.g., the third digital data set X_{Z}) is an idealized representation of the original input to the AI model (e.g., the first digital data set X). This is referred to as “interpretability through invertibility.” In some embodiments, the RISE characteristic of interpretability is measured by the certification system by determining whether one or more layers of an AI model are invertible.

In some embodiments, FIGS. 7 and 8 depict an example of how the certification system determines whether a layer Z 705 of an AI model 799 is invertible. In other words, FIGS. 7 and 8 depict an example of how the certification system determines whether an AI model has the RISE characteristic of interpretability through invertibility. Although FIGS. 7 and 8 depict having just one layer Z 705, in practice the AI model 799 can include a plurality layers Z 705 such as is depicted in FIGS. 9 and 10. The number of layers depicted in FIGS. 7-10 are intended to be illustrative and not limiting.

Referring to FIG. 7, a first digital data set X 162 is inputted to a layer Z 705 of an AI model. The layer Z 705 processes the first digital data set X 162 and outputs the second digital data set Y 164.

Referring to FIG. 8, the second digital data set Y 164 is inputted in the layer Z 705. The layer Z 705 processes the second digital data set Y 164 to output the third digital data set X_{z} 166. The third digital data set X_{z} 166 depicted in FIG. 8 includes an idealized representation of the first digital data set X 162 which is understandable by a human operator 109 to represent the first digital data set X 162 depicted in FIG. 7.

Thus, the AI model 799 depicted in FIGS. 7 and 8 is invertible since its output (e.g., the second digital data set Y 164) can be inverted to yield a digital data set (e.g., the third digital data set X_{z} 166) which is understandable by a human operator 109 to represent the original input to the AI model 799 (e.g., the first digital data set X 162). The human operator 109 can then evaluate the first digital data set X 162 and the third digital data set X_{z} 166 and understand how the layer Z 705 of the AI model 799 processes specific inputs to generate specific outputs, and so, the layer Z 705 of the AI model 799 has the RISE characteristic of interpretability through invertibility. This is beneficial for numerous reasons. For example, the invertibility of the layer Z 705 of the AI model 799 enables a human operator 109 of the AI model 799 initiate the following example analysis process: (1) input specific data to the layer Z 705 (see, e.g., FIG. 7) to generate a output; (2) examine the output of the layer Z 705 relative to the input to understand how the layer Z 705 modified the input and what specific computational units of the layer Z 705 where triggered by the input to the layer Z 705 (see, e.g., FIG. 7); (3) invert the output in the reverse computational direction back through the layer Z in the reverse computational direction to generate an idealized representation of the input to the layer Z 705 (see, e.g., FIG. 8); (4) analyze the idealized representation of the input to the layer Z 705 to compare it to the original input from step 1 and the output of the layer Z 705 which is examined at step 2; (5) repeat steps 1-4 using different types of inputs; and (5) determine precisely how the layer Z 705 performs its task and which computational units of the layer Z 705 are triggered by different types of inputs, thereby providing a detailed understanding of how the algorithm of the layer Z 705 performs its tasks. In some embodiments, this analysis process is repeated for each layer of the AI model 799 in embodiments where the AI model 799 includes multiple layers Z 705. By doing so, the human operator 109 is provided with the information they need to know precisely how the algorithm of the AI model 799 can be modified (for example, to achieve different functionality or be tailed for different use cases).

Metrics Data 195 (“RISE Metrics”)

Modern approaches to AI rely primarily on classification accuracy (referred to herein as “accuracy” or “classification accuracy”) as a metric for determining the performance of an AI model. A problem with AI models that rely solely on accuracy as a metric for determining performance is that accuracy only measures a single aspect of AI model performance and does not fully characterize the success of AI models under real-world conditions. By comparison, the certification system determines the performance of AI models based on an ability of the AI model to comply with the RISE metrics. The certification system determines that an AI model complies with the RISE metrics when the AI model satisfies the set of thresholds for the different RISE metrics.

The RISE metrics include classification accuracy as a measure of the performance of AI models, but also includes additional metrics which enable the certification system to accurately determine whether an AI model will have good performance in the real-world.

An example goal of the RISE metrics is to evolve from measuring the performance of an AI model based solely on classification accuracy and instead measure the performance of an AI model based at least in part on classification accuracy plus one or more of the following RISE characteristics: (1) Robustness; (2) Interpretability through invertibility; (3) Security; and (4) Efficiency (hence, the name “RISE metrics”). Classification accuracy is included in the RISE metrics.

Accordingly, the certification system includes code and routines that are operable to measure one or more of these characteristics of an AI model and issue a certification status to any AI model that satisfies the thresholds for the RISE metrics corresponding to these characteristics: (1) classification accuracy that satisfies a predetermined threshold for classification accuracy; (2) robustness through verified compliance with the four elements of robustness that are described below; (3) interpretability through verified invertibility of each layer of the AI model; (4) security through verified resistance to specified vulnerabilities; and (5) efficiency through satisfaction of a set of thresholds for the efficiency metrics described below. The RISE metrics are now described in more detail.

Classification Accuracy

The classification accuracy metric is a numerical measure of how often an AI model responds with the correct output for a given input. The terms “classification accuracy” and “accuracy” are used interchangeably herein and mean the same thing. Current methods rely on accuracy as the primary metric to evaluate the performance of AI modules. The certification system 199 does not implement this approach. Instead, the certification systems evaluates the performance of AI modules based on: (1) classification accuracy; and (2) an ability of the AI model to satisfy one or more of the thresholds included in one or more sets of thresholds corresponding to the RISE metrics.

Threshold data includes digital data that describes a set of thresholds corresponding to the RISE metrics. An example of the threshold data according to some embodiments includes the threshold data 169 depicted in FIG. 1.

Metrics data includes digital data that describes the RISE metrics tested by the certification system, which threshold described by the threshold data 169 corresponds to which RISE metric, and, for a given AI model, the outcome of the testing done by the certification system (e.g., which of the thresholds the AI model has satisfied and not satisfied). An example of the metrics data according to some embodiments includes the metrics data 195 depicted in FIG. 1.

Classification accuracy, or “accuracy,” is determined differently by the certification system depending on the specific task the AI model is programmed to perform. An example of accuracy is now provided with reference to FIG. 7. The example is referred to herein as the “woolly mammoth example.” The woolly mammoth example is now described according to some embodiments by way of examples.

For example, with reference to FIG. 7, assume that an input (i.e., a first digital data set X 162 depicted in FIG. 7) to an AI model includes image data. The image data includes digital data that describes one or more images. Within the images are areas of pixels. Within some of these areas may or may not be patterns of pixels which are recognizable by a human as being within one or more categories. In the woolly mammoth example, when one or more of the images inputted to the AI model include areas having a pattern of pixels that a human would recognize as being a woolly mammoth (e.g., the category in this example is a woolly mammoth), then the AI model outputs digital data (i.e., the second digital data set Y 164) that indicates (1) which of these images include patterns of pixels that a human would recognize as being a woolly mammoth and (2) which of these images do not include a pattern of pixels that a human would recognize as being a woolly mammoth. The AI model can be trained to identify other patterns of pixels. For example, in practice an AI model trained to recognize woolly mammoths is also trained to classify one or more other categories so that it can distinguish those categories from a woolly mammoth. This example is intended to be illustrative and not limiting.

Further assume in the woolly mammoth example that the AI model is configured to receive image data (e.g., the first digital data set X 162 depicted in FIG. 7) as an input. The image data describes a set of images. The AI model outputs digital data (e.g., the second digital data set Y 164 depicted in FIG. 7) that includes a version of the image data that is modified so that: (1) the set of images include categorical labels describing which areas within these images include a predetermined pattern (in the woolly mammoth example the pattern sought by the AI model is patterns of pixels which collective depict a woolly mammoth or human-recognizable portions of a woolly mammoth); and (2) information indicating which of the images within the set of images does not include any instance of the pattern sought by the AI model (e.g., if an image does not include any area of pixels that includes a pattern of pixels that a human would recognize as a woolly mammoth or a portion of a woolly mammoth, then the output includes digital data that indicates this circumstance).

In some embodiments, the AI model further modifies the images that are input to the AI model so that the output of the AI model in the forward computational direction includes images that depict an idealized representation of whatever is depicted in the input. For example, the AI model modifies the images in some way that is beneficial for the purpose of identifying patterns of pixels within the images. Example beneficial modifications which aide in identifying patterns of pixels include one or more of denoising, canonicalization, and other examples that are described below with reference to “Input Enhancement Metric.”

In some embodiments, the output of the AI model in the forward computational direction (e.g., the second digital data set Y 164 depicted in FIG. 7), when an AI model is configured to determine categorical labels for images, includes digital data describing one or more of the following: (1) categorical labels for one or more areas of pixels which are determined by the AI model to include, within the area, the pattern of pixels which the AI model is programmed to identify (e.g., based on the training data used to train the AI model); (2) information identifying specific images within the first digital data set X 162 include areas of pixels having the pattern of pixels which the AI model is programmed to identify; (3) information identifying, within these specific images, the location of the area of pixels where the pattern of pixels is present; (4) a version of the first digital data set X 162 which is modified by the AI model so that the images include categorical labels for the area of pixels where the pattern of pixels is identified by the AI model; and (5) for any image in the first digital data set X 162 which did not include any area of pixels having the pattern of pixels which the which the AI model is programmed to identify, digital data describing that the pattern of pixels is not present (e.g., a categorical label applied to the image indicating that the image does not include any instance of the pattern sought by the AI model).

Training data is now introduced. Training data includes digital data that is inputted to an AI model during a training stage of developing the AI model to train the AI model how to perform a particular task. For example, if the AI model is trained to recognize one or more patterns of pixels in images and apply categorical labels to areas of pixels within these images that include these patterns, then the training data includes image data including images that contain areas of pixels that include these patterns and categorical labels applied to these areas as an indication that these specific areas include a specific known pattern. An example of the training data according to some embodiments includes the training data 196 depicted in FIG. 1.

In the woolly mammoth example, the training data includes image data describing (1) images of a set of objects (e.g., woolly mammoths) and (2) categorical labels for these objects (e.g., areas of pixels within the images that depict a “woolly mammoth” are categorically labeled “woolly mammoth” or some other indication that is known by a human user to mean that the area of pixels includes a pattern that they would recognize as a woolly mammoth). The images in this training data are used to train the AI model how to: (1) recognize areas of pixels within images that include patterns of pixels which match the patterns of pixels included in the training data which was used to train the AI model; and (2) categorically label the areas of pixels within the images to indicate that they include at least one instance of the patterns of pixels included in the training data used to train the AI model. In other words, the AI model which is certified by the certification system as compliant with the RISE metrics is operable to identify and positively express: (1) when images include the patterns sought by the AI model; and (2) which categorical label corresponds to each pattern.

Continuing with the woolly mammoth example, assume that the training data used to train an AI model includes patterns of pixels that a human would recognize as being a woolly mammoth (or portions of a woolly mammoth) and that the AI model is trained and configured identify images that depict woolly mammoths and categorically label these images as depicting woolly mammoths as described herein.

Now assume that the AI model receives a set of images as an input and some of these images depict woolly mammoths whereas some of these images depict elephants (which are visually similar, but ultimately different in appearance from a woolly mammoth since, for example, elephants do not have as much hair as a woolly mammoth, among other differences). The images that depict woolly mammoths are in a subset A and the images that depict elephants are in a subset B. If the AI model is certified by certification system as compliant with the RISE metrics, then the AI model is able to analyze the set of images received as an input and generate an output that includes digital data that includes a modified version of the set of images that includes, among other modifications and enhancements, categorical labels for images in subset A that specifies, for each image, the pixel areas within the image that depict woolly mammoths (or portions of a woolly mammoth) and information for the images in the subset B that specifies that these images do not include any pixel areas having patterns of pixels that match a woolly mammoth.

As a different assumption, assume that the AI model receives a set of images as an input and none of these images depict woolly mammoths whereas some of these images depict elephants. If the AI model is certified by certification system as compliant with the RISE metrics (e.g., because the tests conducted by the certification system shows that the AI model satisfies one or more sets of thresholds corresponding to the individual RISE metrics), then the AI model is able to analyze the set of images received as an input and generate an output digital data that specifies that none of the images inputted to the AI model include any pixel areas having patterns of pixels that match a woolly mammoth (or a portion of a woolly mammoth). By contrast, AI models that are based on DL would commonly label the images that depict elephants as being images that depict woolly mammoths since elephants and woolly mammoths are visually similar.

All references herein to the woolly mammoth example are intended to be illustrative and not limiting. It is not required that the training data include images of woolly mammoths. AI models that are compliant with the RISE metrics are able to identify other patterns. Images of any other pattern of pixels can be used to train the AI model. Accordingly, the images used to train the AI model can be images of any pattern of pixels. For example, the AI model may be trained to recognize other types of images, colors, noise patterns, or any other characteristic of images.

The certification system is not limited to certifying AI models that categorically label images. The certification system is able to certify AI models that process any type of digital data. For example, the certification system is operable to certify AI models that are operable to categorically label audio data. The audio data includes digital data that describes one or more audio tracks. The training data for such an AI model includes a set of audio data which includes specific patterns of audio present within the audio of an audio track which is recognizable by a human as having one or more characteristics.

In some embodiments, the AI models certified by the certification system are not limited to recognizing patterns in images or audio. For example, the certification system certifies AI models are capable of recognizing any type of pattern or predicting any type of information within any type of digital data.

Model Accuracy Metric

The model accuracy metric (or the “accuracy metric”) utilized by the certification system is now described with reference to the woolly mammoth example. The accuracy metric includes digital data that describes how accurate the AI model is at correctly identifying patterns of pixels (e.g., whatever pattern the AI model is trained to identify) within a set of image data (e.g., the first digital data set X 162 depicted in FIG. 7) and applying correct categorical labels to areas of pixels within one or more images that includes these patterns of pixels (e.g., labeling the “woolly mammoths” as being “woolly mammoths” and not incorrectly labeling “elephants” as being “woolly mammoths”).

For example, both of the following are true about the operation of an accurate AI model that has been certified by the certification system and trained to analyze images for the presence of patterns of pixels matching that of a woolly mammoth and categorically label images that include patterns of pixels that match (or substantially match) the images of woolly mammoths used to train the AI model: (1) if image data inputted to the AI model includes a pattern of pixels that a human would recognize as being an image of a woolly mammoth, then the AI model outputs a modified version of the image that includes enhancements and at least one categorical label applied to the area of pixels within the image that includes the pattern of pixels that the human would recognize as being an image of the woolly mammoth; and (2) if image data inputted to the AI model does not include a pattern of pixels that a human would recognize as being an image of woolly mammoth or any other pattern the AI model has been trained to recognize (e.g., the image depicts an elephants but not a woolly mammoth), then the AI model outputs a modified version of the image that includes enhancements and digital data indicating that the AI model does not know what category of object or objects are depicted in the image (e.g., the AI model indicates that it “does not know” what is depicted in the image). This is an example of an accurate AI model since the AI model does not provide a false positive categorical label. This is also an example of “open set recognition” since the AI model correctly indicates when the image data inputted to the AI model is not within the training data used to train the AI model. Open set recognition is described in more detail below (see, e.g., the description of “Robustness Metric”).

The certification system includes code and routines that are operable to determine the accuracy of the AI model and whether this accuracy satisfies an accuracy threshold that is described by the threshold data. The threshold data includes digital data that describes one or more thresholds. For example, the threshold data describes any threshold described or implied herein. An example of the threshold data according to some embodiments includes the threshold data 169 depicted in FIG. 1.

In some embodiments, the accuracy threshold describes a minimum accuracy rate for an AI model for correctly identifying patterns within inputs to the AI model based on the training data used to train the AI model. The AI model then labels the patterns (e.g., patterns of pixels) within the output of the AI model and the certification system determines if these labels are accurate (e.g., “classification accuracy”).

In some embodiments, the certification system determines if the accuracy threshold is satisfied by the performance of the AI model over a set number of operations of the AI model. If the performance of the AI model satisfies the accuracy threshold, then the certification system determines that the AI model has satisfied the accuracy metric. If the AI model satisfies the accuracy metric, then the AI model is compliant with the accuracy metric. The same is true for the other metrics: satisfying a set of thresholds for a given metric indicate that the AI model is compliant with that metric and failing to satisfy the set of thresholds for a given metric indicate that the AI model is noncompliant with that metric.

In some embodiments, the accuracy threshold describes a minimum accuracy rate for the AI model at correctly inferring matches between patterns within the inputs to the AI model and the training data used to train the AI model (e.g., “inference accuracy”). The certification system determines if the accuracy threshold is satisfied by the performance of the AI model over a set number of operations. If the performance of the AI model satisfies the accuracy threshold, then the certification system determines that the AI model has satisfied the accuracy metric.

By contrast, an inaccurate AI model is one that has been trained to analyze images and categorically label images that include depictions of woolly mammoths, however, if the AI model receives image data that does not include a pattern of pixels that a human would recognize as being an image of woolly mammoth (e.g., the image depicts an elephants but not a woolly mammoth), then the AI model outputs a modified version of the image that includes a categorical label applied to the image indicating that the image includes within it a pattern of pixels that a human would recognize as a woolly mammoth even though the image does not include a pattern of pixels that a human would recognize as a woolly mammoth. This behavior is common among AI models built based on DL. An example reason for this type of error is that the AI model is configured to find a “closest match” for any input it receives among whatever images are used to train the AI model, and it outputs whatever is the best match it finds from among the training data (e.g., an image of an elephant is sufficiently similar to images of woolly mammoths used to train the AI model, and so the AI model outputs digital data corresponding to the image depicting a woolly mammoth). If this AI model repeated this same type of error multiple times, then this AI model would not be certified by the certification system since, among other things, it is prone to false positives and the evidence indicates that it is not capable of open set recognition (e.g., it cannot accurately indicate when it “does not know” or provide a UDI). AI models built based on DL are incapable of open set recognition.

Robustness Metric

In some embodiments, the certification system determines whether an AI model satisfies the robustness metric by executing one or more of the following tests for the AI model: (1) an extrapolation test; (2) an adaption test; (3) an open set recognition test; and (4) a runtime learning test. An AI model that satisfies a robustness metric is compliant with the robustness metric. These tests are now introduced according to some embodiments.

In some embodiments, the extrapolation test measures an ability of an AI model to accurately process data that differs statistically and qualitatively from its training data.

In some embodiments, the adaptation test measures an ability of an AI model to improve its performance by first using a short interval of observation to measure any changes in the statistics of its inputs and then adapting its internal parameters to take these changes into account. The internal parameters include, for example, the parameters “p” of a function f(x; p) included in the code and routines of the AI model or the variables to an algorithm included in the AI model.

In some embodiments, the open set recognition test measures an ability of an AI model to accurately identify when inputs are random/unstructured or structured in a way not representative of the training data. For example, the open set recognition test measures an ability or characteristic of the AI model to accurately indicate a UDI when the patterns within the inputs to the AI model are recognized by the AI model as not being sufficiently similar to the training data used to train the AI model. By contrast, AI models that fail the open set recognition test do not possess this ability or characteristic, and instead always make a “best guess” based on the training data used to train the AI model where the best guess corresponds to the portion of the training data that is the “best fit” for a pattern present in the input, even when inaccurate or inappropriate.

In some embodiments, the runtime learning test measures an ability of an AI model to learn new data categories in an unsupervised manner (which is useful for organizing data unknown to the AI model as structured feedback to a human that designs or maintains the AI model).

Test data includes digital data that describes any digital information that is necessary to perform the tests described herein. For example, the test data includes digital data that describes images, audio, noise patterns, etc. An example of the test data according to some embodiments includes the test data 194 depicted in FIG. 1.

These tests are now described in more detail below. As will be described, some of these tests individually include one or more categories of tests that are executed by the certification system. For example, the extrapolation test itself includes four different categories of tests, and the certification system executes one or more of these categories of tests to measure the extrapolation abilities of an AI model when determining whether an AI model satisfies the robustness metric.

Accordingly, many tests and categories of tests are described herein. In some embodiments, the certification system can execute any combination of these tests and and/or subtests when determining whether an AI model satisfies one or more of the metrics described herein. In some embodiments, passing a test for one metric is a prerequisite for passing another test for another metric. Accordingly, the tests and metrics are interrelated to one another in some embodiments.

The certification system is described herein as performing various steps and operations. This language is used for convenience. In practice, the certification system includes code and routines that are operable, when executed by a processor (e.g., the processor 125 depicted in FIG. 1), to cause the processor to execute these steps and operations. For example, below the certification system is described as performing various tests. In practice, the certification system includes code and routines that are operable, when executed by a processor, to cause the processor to execute the steps and/or operations for the various tests.

Robustness Metric: Extrapolation Tests

In some embodiments, the certification system executes one or more of the following categories of extrapolation tests when determining whether an AI model satisfies the robustness metric: (1) a corruption test; (2) a distraction test; and (3) a distortion test. These categories of tests include the certification system modifying an original set of digital data (the original set of digital data is referred to herein as the “original input” and an example of the original input in some embodiments includes the first digital data set X 162 depicted in FIG. 7) to generate a “modified input” that is then inputted to the AI model to determine an ability of a trained AI model to extrapolate information from the modified input relative to the ability of the AI model to extrapolate information from the original input. These three categories of tests are now described in more detail.

The corruption test category is now described according to some embodiments. The certification system is operable to determine the ability of an AI model to extrapolate from corrupt inputs to the AI model by (1) deliberately generating and inputting degraded digital data to the AI model and (2) assessing changes in the ability of the AI model to correctly identify patterns in the input relative to the prior ability of the AI model to correctly identify patterns in uncorrupted inputs to the AI model. For example, the certification system includes code and routines that are operable, when executed by a processor, to cause the processor to (1) deliberately generate and input randomly generated noise into the AI model and (2) determine changes in the ability of the AI model to correctly identify patterns in the input relative to the prior ability of the AI model to correctly identify patterns in uncorrupted inputs to the AI model (e.g., some or all of the training data that was used to train the AI model or any set of images that are relatively free of randomized noise or otherwise not modified to include randomized noise).

In some embodiments, the certification system determines whether the ability of the AI model to correctly identify patterns in the corrupted input relative to the prior ability of the AI model to correctly identify patterns in non-corrupted inputs (e.g., the original input) to the AI model satisfies a robustness threshold which is described by the threshold data. If so, then the certification system determines that the AI model is eligible to be certified by the certification system. If not, then the certification system determines that the AI model is not eligible to be certified by the certification system.

In some embodiments, various levels of noisy inputs are inputted to the AI model to determine the extrapolation ability of the AI model at different levels of noise. In some embodiments, the noise level of the noisy inputs to the AI model are measured in signal-to-noise ratio (SNR).

The distraction test category is now described according to some embodiments. The certification system is operable to determine the ability of an AI model to extrapolate from distracting inputs to the AI model by deliberately inputting digital data to the AI model which is configured by the certification system to “confuse” the AI model.

The distraction test category is now described with reference to image recognition. For example, the certification system includes code and routines that are operable, when executed by a processor, to cause the processor to add non-randomized visual clutter to digital data describing an image (e.g., an example of an original input) so multiple objects are present in a single input (herein, a “distracting input”). This is an example of a digital data that is configured by the certification system to “confuse” or “distract” the AI model. The certification system then determines changes in the ability of the AI model to correctly identify patterns in the distracting input relative to the prior ability of the AI model to correctly identify patterns in non-distracting inputs to the AI model (e.g., the original input or any other digital data that is relatively free of non-randomized distracting factors or not modified to include non-randomized distracting factors).

In some embodiments, the certification system determines whether the ability of the AI model to correctly identify patterns in the distracting input relative to the prior ability of the AI model to correctly identify patterns in non-distracting inputs (e.g., the original input) to the AI model satisfies a robustness threshold. If so, then the certification system determines that the AI model is eligible to be certified by the certification system. If not, then the certification system determines that the AI model is not eligible to be certified by the certification system.

Another example of digital data that is selected by the certification system to “confuse” or “distract” an AI model configured for image recognition includes inputting digital data to the AI model that includes an image to be recognized that is placed in a non-contextual background. For example, the AI model is configured to recognize patterns of pixels that a human would recognize as a kitchen appliance, and the “confusing” input to the AI model includes an image of a kitchen appliance in a forest setting or some other setting that is out of context for a kitchen appliance. This input, while confusing, is not randomized because the non-contextual background added to the original input by the certification system to form the distracting input are selected to be a background that is non-contextual relative to the object depicted in the original input.

The certification system includes code and routines that are operable, when executed by a processor, to cause the processor to determine changes in the ability of the AI model to correctly identify patterns in the distracting input relative to the prior ability of the AI model to correctly identify patterns in non-distracting inputs to the AI model (e.g., the original input or any other digital data that is relatively free of non-randomized distracting factors or not modified to include non-randomized distracting factors). In some embodiments, the certification system determines whether the ability of the AI model to correctly identify patterns in the distracting input relative to the prior ability of the AI model to correctly identify patterns in non-distracting inputs to the AI model satisfies a robustness threshold. If so, then the certification system determines that the AI model is eligible to be certified by the certification system. If not, then the certification system determines that the AI model is not eligible to be certified by the certification system.

The distraction test category is now described with reference to audio recognition. For example, the certification system adds music or some other structured, non-random background sounds to recorded speech (e.g., the original input) to form the distracting input. In the audio domain, music added to recorded speech could distract a speech recognition model from correctly identifying the recorded speech which the AI model is trained to recognize.

The certification system then determines changes in the ability of the AI model to correctly identify patterns in the distracting input relative to the prior ability of the AI model to correctly identify patterns in non-distracting inputs to the AI model (e.g., the original input or any other input that is relatively free of non-randomized distracting factors or not modified to include non-randomized distracting factors). In some embodiments, the certification system determines whether the ability of the AI model to correctly identify patterns in the distracting input relative to the prior ability of the AI model to correctly identify patterns in non-distracting inputs to the AI model satisfies a robustness threshold. If so, then the certification system determines that the AI model is eligible to be certified by the certification system. If not, then the certification system determines that the AI model is not eligible to be certified by the certification system.

Note that the distraction use differs from the corruption use case because the certification system adds structured information to the input instead of random information to the input.

The distortion test category is now described. For example, the certification system modifies an original input with filters and/or transformations that significantly alter the statistical characteristics of the original input but not the identity of the content of the original input, to form a “distorted input.” For example, the low-level properties of the input are altered without altering its identity. The distorted input is then inputted to the AI model to test an ability of the AI model to extrapolate information from the distorted input.

The distorted test category is now described with reference to image recognition. For example, the certification system includes code and routines that are operable, when executed by a processor, to cause the processor to modify normal image data (e.g., an original input) with filters to generate a distorted input in which aspects of the image described by the image data are modified in such a way that statistical characteristics of the image are modified but not the identity of the object depicted in the image. The filters used by the certification system modify, for example, the tint of the image, the lighting of the image, the saturation of the image, the contrast of the image, the blur of the image, or one or more other properties which are modifiable in the image without modifying the content of the image (e.g., the objects depicted in the image). These modifications are individually or collectively referred to as “distorting factors.” For example, the original input is a color image of a banana, but the image is modified so that the banana is pink instead of yellow or green. The distorted input is then inputted to the AI model which is trained to recognize a particular pattern of pixels or set of patterns of pixels (e.g., an image or a banana that is yellow or green).

The certification system then determines changes in the ability of the AI model to correctly identify patterns in the distorted input relative to the prior ability of the AI model to correctly identify patterns in non-distorted inputs to the AI model (e.g., the original input or any other digital data that is free of distorting factors or not modified to include distorting factors).

In some embodiments, the certification system causes a processor to use filters to generate a distorted input with enhanced distorting factors. In some embodiments, the certification system uses filters that convert digital data describing a real-life image (e.g., an original input) into digital data that describes a cartoon, caricature, or line-drawing version of the real-life image (i.e., “enhanced distorting factors”), which then become the distorted input which is inputted to the AI model by the certification system. For example, a real-life image of a banana (e.g., an original image) is modified by the certification system to be a cartoon version of the real-life image of the banana (e.g., a distorted input). The certification system then determines changes in the ability of the AI model to correctly identify patterns in the distorted input relative to the prior ability of the AI model to correctly identify patterns in non-distorted inputs to the AI model (e.g., the original input or any other image that is relatively free of distorting factors or not modified to include distorting factors).

In some embodiments, the certification system determines whether the ability of the AI model to correctly identify patterns in the distorted input relative to the prior ability of the AI model to correctly identify patterns in non-distorted inputs to the AI model satisfies a robustness threshold. If so, then the certification system determines that the AI model is eligible to be certified by the certification system. If not, then the certification system determines that the AI model is not eligible to be certified by the certification system.

The distorted test category is now described with reference to audio recognition. For example, the certification system modifies normal audio data with filters to generate a distorted input in which aspects of the audio described by the audio data are modified in such a way that statistical characteristics of the audio are modified but not the focal point of the audio. Examples of the focal point of audio include speech, lyrics, spoken words, a discrete noise (e.g., the sound made by a particular source of vibration such as a particular instrument or individual that is speaking), or some other discrete aspect of the audio. The filters used by the certification system to generate the distorted input modify, for example, one or more of the equalization levels of the audio, clipping within the audio, and applying reverb or other effects to the audio, and any other modification to the audio that modifies a low-level aspect of the audio but not the focal point of interest of the audio (where “focal point of interest” is the portion of the audio that is the main point of interest within the audio). The distorted input is then inputted to the AI model which is trained to recognize a particular pattern of sound within the audio or set of patterns of sound within the audio. The certification system then determines changes in the ability of the AI model to correctly identify patterns in the input relative to the prior ability of the AI model to correctly identify patterns in non-distorted inputs to the AI model (e.g., the training data used to train the AI model or other images that are relatively free of non-randomized distracting factors).

In some embodiments, the certification system determines whether the ability of the AI model to correctly identify patterns in the distorted input relative to the prior ability of the AI model to correctly identify patterns in non-distorted inputs to the AI model satisfies a robustness threshold. If so, then the certification system determines that the AI model is eligible to be certified by the certification system. If not, then the certification system determines that the AI model is not eligible to be certified by the certification system.

In some embodiments, the certification system tests for the extrapolation abilities of an AI model using one or more of the tests described above to generate a modified input from an original input. For example, an image of a real-life yellow banana sitting on a dinner table (e.g., an original input) is modified by the certification system to be cartoon image of a pink banana floating in space and the cartoon version of the image includes randomized noise added (e.g., a modified version of the original input). This modified version of the original image includes all three categories of tests from the extrapolation abilities of an AI model: (1) corruption (i.e., noise); (2) distraction (i.e., non-contextual background, specifically, space); and (3) distortion (i.e., the banana is both pink and transformed into a cartoon version of the real-life image).

In some embodiments, the certification system includes code and routines that are operable, when executed by a processor, to cause the processor to execute one or more of the test categories described above when determining whether an AI model satisfies the robustness metric. In some embodiments, the certification system executes any combination of these test categories when determining whether an AI model satisfies the robustness metric.

In some embodiment, one or more of the test categories for extrapolation measure classification accuracy as a function of the level of each of these types of modifications to the input. For example, the certification system measures the classification accuracy of images versus level of additive noise (corruption) added to the original input by the classification system.

Robustness Metric: Adaption Tests

In some embodiments, adaptation is a variant of extrapolation with the additional feature of the AI model being able to use a short interval of observation to statistically characterize the modified input (i.e., the modified version of the original input created by the certification system) and use this characterization to adjust the parameters of the AI model. The short interval of observation is referred to herein as the “adaption process.” In some embodiments, this adaptation process leads to a higher level of performance by the AI model than the tests outlined above for extrapolation.

One or more steps of the following process is referred to herein as an adaption test: (1) generating a modified input; (2) inputting it to an AI model; (3) executing the adaption process; (4) observing the AI model generating new parameters based on analysis of the modified input; (5) observing the AI model modifying its pattern recognition processes using the new parameters; (6) receiving the output of the AI model; (7) comparing this output to other outputs generated by the AI model using unmodified inputs to determines changes in the ability of the AI model to correctly identify patterns in the digital data inputted to the AI model; and (8) determine the adaptability of the AI model relative to a robustness threshold described by the threshold data (e.g., an adaptability threshold or a robustness threshold).

In some embodiments, the certification system includes code and routines that are operable, when executed by a processor, to cause the processor to generate the modified inputs used for the adaption tests using processes similar to those described above for the extrapolation element of robustness.

In some embodiments, the amount of digital data used for execution of the adaption tests are far less (e.g., orders of magnitude less) than used to train the AI model (e.g., the modified inputs used for the adaption tests is orders of magnitude less than the training data as measured in bits, thereby creating computational efficiency relative to the training process). For example, consider the use cases of the certification system executing an adaptability test for an AI model by creating a modified input based on changing a color tinting of an image or the equalization of an audio file in order.

Adaptability of an AI model is now described according to some embodiments. For example, after observing a short sequence of images with the new tinting or a short audio clip with the new equalization, the AI model includes a feedback loop that causes the AI model to statistically characterize the modified input and the performance of the AI model at identifying patterns in the modified input; the AI model then determines parameters that are operable to cause the AI model to better identify one or more patterns that the AI model is trained to recognize within digital data inputted to the AI relative to the performance of the AI model prior to the determination of the parameters. This is referred to the as an “adaptation process.” The AI model proceeds to process the modified input in accordance with its programming. In some embodiments, this programming includes additional feedback loops that cause the AI model to generate additional new parameters for modifying the operation and performance of the AI model for additional adaption processes. This is an example according to some embodiments of how an AI model is programmed to be adaptable to the characteristics of the digital data inputted to the AI model.

In some embodiments, the more adaptable an AI model is programmed to be, the more robust the AI model is determined to by the certification system. The certification system includes code and routines that are operable, when executed by a processor, to cause the processor to quantify the adaptability of an AI model and determine whether this adaptability satisfies a robustness threshold which is described by the threshold data (e.g., an adaptability threshold, which is a specific type of robustness threshold according to some embodiments).

In some embodiments, the certification system uses the same tests for quantifying adaptability (e.g., one or more adaptability tests) of an AI model that are used by the certification system for quantifying extrapolation (e.g., one or more extrapolation tests) of an AI model, with the added condition that the certification system also measures and considers how much digital data (e.g., bits of data included the modified input) is made available to the AI model during an adaption process (or, if multiple adaption processes are executed by the AI model, the sum of the digital data utilized by the AI model for all of the adaption processes that it executes) when quantifying the adaptability of an AI model. In this way the certification system generates a determination of whether an AI model satisfies an adaptability threshold in some embodiments. For example, the outcome of an adaptability test for an AI model trained to recognize patterns in audio is quantified by the certification system as recognition accuracy at a signal-to-noise ratio which is classified by the certification system as being “low signal-to-noise ratio” for differing lengths of noisy speech the AI model was allowed to use for observation during an adaption process. In other words, the AI model is given low quality audio for a period of time to see if the AI model can adapt and recognize patterns with more accuracy over time after the adaptation period. The certification system then compares this quantification to an adaptability threshold to determine if the adaptability threshold is satisfied by the performance of the AI model. As the amount of digital data inputted to the AI model during the adaption process approaches zero, the performance of the AI model at recognizing patterns as observed by the certification system during the adaption test converges to be the same as the performance of the AI model at recognizing patterns as observed by the certification system during the extrapolation test.

Robustness Metric: Open Set Recognition Test

In some embodiments, the certification system includes two categories of tests for the open set recognition component of robustness: (1) a random input test; and (2) an unknown input test.

The random input test is now described according to some embodiments. In some embodiments, the random input test includes the certification system generating a test input randomly through a process that produces unstructured data that includes digital data that has no human-recognizable or semantically interpretable content. The certification system includes code and routines that are operable, when executed by a processor, to cause the processor to generate and input this test input (e.g., first digital data set X) to the AI model and measure the performance of the AI model to: (1) recognize that the test input does not include the pattern that the AI model is trained to recognize; and (2) output second digital data set Y that indicates that the pattern is not within the test input (e.g., a UDI). The certification system includes code and routines that are operable, when executed by a processor, to cause the processor to determine that the AI model satisfies the open set recognition metric (which is a subcategory of the robustness variant) if the AI model outputs second digital data set Y that indicates that the pattern that the AI model is trained to recognize is not within the test input.

The unknown input test is now described according to some embodiments. In some embodiments, the unknown input test includes the certification system generating a test input by selecting the test input from structured data semantically unrelated to the training data used to train a particular AI model that is being subjected to the unknown input test by the certification system For example, the certification system includes code and routines that are operable, when executed by a processor, to cause the processor to select a test input from a set of test data that includes digital images of plants, vehicles and buildings for an AI model trained to recognize animal images, and this is an example of structured data semantically unrelated to the training data used to train a particular AI model that is being subjected to the unknown input test. The certification system includes code and routines that are operable, when executed by a processor, to cause the processor to input this test input (e.g., first digital data set X) to the AI model and measure the performance of the AI model to: (1) recognize that the test input does not include the pattern that the AI model is trained to recognize; and (2) output second digital data set Y that indicates that the pattern is not within the test input (e.g., a UDI). The certification system includes code and routines that are operable, when executed by a processor, to cause the processor to determine that the AI model satisfies the open set recognition metric (which is a subcategory of the robustness variant) if the AI model outputs second digital data set Y that indicates that the pattern that the AI model is trained to recognize is not within the test input.

In some embodiments, the open set recognition test executed by the certification system measures how often the AI model correctly indicates that the random or unknown input is unrecognizable by the AI model (e.g., a UDI). This indication can either be active (e.g., a specific output signal indicating “unknown input”) or through collective inactivity (e.g., all of the model outputs are set to zero).

In some embodiments, the open set recognition metric is beneficial because AI models are typically trained with a closed set of training data (e.g., training data representing a limited set of categories), but once deployed, many AI models are exposed to a much larger range (an “open set”) of input data categories. Under real-world deployment conditions, it is beneficial for a human operator of an AI model be alerted when inputs to the AI model fall outside the range of the training data used to train the AI model. It is also useful to have AI models that can indicate lack of confidence in outputs or simply signal “unknown input,” or the equivalent thereof. In some embodiments, AI models that are certified by the certification system possess these characteristics.

Robustness Metric: Runtime Learning Test

In some embodiments, the runtime learning ability of the AI model is a function of both the adaptability and the open set recognition ability of the AI model being tested for certification by the certification system. The runtime learning ability of an ability of a fully trained AI model to adapt to post-deployment changes with the unsupervised learning of new input categories included in the first digital data set X inputted to the AI model.

For example, an AI model trained exclusively on images of people and cars deployed for use as an element of an image recognition system placed to observe a residential street may frequently observe dogs, which it should accurately identify as “unknown” if it is certified by the certification system since this is a requirement of the open set recognition threshold. By processing these unknown stimuli with extra units reserved for runtime learning, over time the AI model will learn to recognize dogs even though not initially trained with dog images, provided that the AI model has sufficient runtime learning ability to satisfy the runtime learning test implemented by the certification system. A human designer or user of the AI model is then able to examine the examples from this novel category, potentially assign it a semantic label, and optionally decide that dogs should be added to the training data of the AI model.

Accordingly, a runtime learning test executed by the certification system on an AI model measures an ability of the AI model to accurately learn a new category of structured data which is not present in the training data used to train the AI model but which is present in a set of test inputs inputted to the AI model by the certification system over the course of the runtime learning test.

In some embodiments, the certification system executes the runtime learning test by executing one or more of the following steps: (1) executing an open set recognition test using a set of test inputs including a new category of structured data not present in the training data used to train the AI model but which is present in the set of test inputs inputted to the AI model; (2) determining the outcome of the open set recognition test; (3) responsive to the AI model being tested passing the open set recognition test by satisfying the open set recognition threshold (e.g., by outputting “unknown” responsive to an input not within the training data used to train the AI model), the certification system begins the runtime learning test by continuing to input the same set of test inputs used in the open set recognition test to the AI model during the runtime learning test (if the AI model does not pass the open set recognition test, then this process ends here and does not proceed to step 4); (4) observe the AI model process the set of test inputs over time to determine whether the AI model attempts to adapt learn the new category of input which is included in the test input and, optionally, measure the amount of time or number of iterations necessary for the AI model to learning the new category of input; (5) responsive to the AI model outputting digital data (second digital data set Y) describing the new category of input, analyze the description of the new category to determine whether the description is accurate (if the AI model does not output digital data describing a new category, then this process ends here, the process does not proceed to step 6, and the AI model does not satisfy the runtime learning threshold; (6) compare the accuracy of the new category to the runtime learning threshold to determine whether the runtime learning threshold is satisfied; and (7) the certification system determines that the AI model satisfies the runtime learning threshold (and therefore satisfies the runtime learning metric which is a subcategory of the robustness variant) if the AI model outputs second digital data set Y that accurately indicates a new category of structured data within the set of test inputs and not present in the training data used to train the AI model and the accuracy of this description is sufficiently accurate to satisfy the runtime learning threshold.

Interpretability Metric

The interpretability metric quantifies an ability of an AI model to reconstruct an idealized representation of an input to the AI model based solely on the output of the AI model. Interpretability is tested by the certification system using an interpretability test. An example of the interpretability test is depicted in FIGS. 7 and 8, considered collectively. For example, a first digital data set X is inputted to an AI model and the AI model generates, in a forward computational direction, a second digital data set Y as an output (see, e.g., FIG. 7); this AI model satisfies an interpretability test if the second digital data set Y can be inputted to the AI model, in a reverse computational direction, to yield a third digital data set X_{Z} that is an idealized representation of the first digital data set X that is used to generate the second digital data set Y (see, e.g., FIG. 8).

An example architecture for an AI model is depicted in FIGS. 9 and 10. In some embodiments, the code and routines included in an AI model includes of a set of sequential processing layers (see, e.g., FIGS. 9 and 10 which include a set of sequential processing layers in a series). In some embodiments, one or more of the layers of an AI model is composed of individual processing units. A processing unit included in a given layer of the AI model receives a set of numerical inputs from the previous layer and includes code and routines that are operable to cause a processor (e.g., the processor 125 depicted in FIG. 1) to produce a single numerical output based on the input to the processing unit of the given layer. An example of this concept is depicted in FIG. 7 where each processing unit 710, 715 receives multiple inputs and they each generate a single output.

For example, an AI model trained to recognize patterns of pixels in images begins with digital data describing a set of image pixels the first digital data set X inputted to the first layer of the AI model. In the first layer of the AI model, units typically detect simple patterns (although this is not a requirement). For example, units in the first layer detect simple patterns such as oriented edges in small, local regions of pixels. At each subsequent layer in the AI model, the small features detected by the previous layer are combined into larger and more complex features, until the last layer is able to accurately categorize the pattern of pixels that are included the set of image pixels that are inputted to the AI model.

In some embodiments, an AI model is invertible if the collective output of any specific layer Z of the AI model can be inverted to produce an idealized representation of the input to that layer Z. The AI model includes a plurality of layers Z. If each layer Z is invertible, then no matter how many layers Z the AI model contains, the output can always be inverted all the way back to the first layer Z₁, producing an idealized representation of the first digital data set X that is inputted to the AI model. For AI models trained to provide image recognition functionality, this means that the output of any layer can be inverted back into an idealized representation of the set of image pixels described by the first digital data set X.

In some embodiments, each successive layer in an AI model adds a degree of abstraction to the processing of the input to the AI model to generate its output in the forward computational direction. Accordingly, inverting each subsequent layer of the AI model in the reverse computational direction yields an increasingly idealized version of the original input to the AI model.

For example, with reference to FIG. 9, depicted is the forward computational direction of an AI model 900 processing a first digital data set X 162 inputted to the AI model 900. The second digital data set Y₁ 164A outputted by the first layer Z₁ is more abstract that the first digital data set X 162 inputted to the first layer Z₁. The second digital data set Y₂ 164B outputted by the second layer Z₂ is more abstract than the second digital data set Y₁ 164A inputted to the second layer Z₂, and so on. Accordingly, each successive layer in an AI model 900 adds a degree of abstraction to the processing of the first digital data set X 162 inputted to the AI model 900 to generate its output, the second digital data set Y_{N} 164N, in the forward computational direction.

With reference to FIG. 10, depicted is the reverse computational direction of an AI model 900 inverting a second digital data set Y_{N} 164N through the AI model 900. The second digital data set Y₁ 164A outputted by the Nth layer Z_{N} is more idealized that the second digital data set Y_{N} 164N inputted to the Nth layer Z₁. The second digital data set Y₁ 164A outputted by the second layer Z₂ is more abstract than the second digital data set Y₂ 164B inputted to the second layer Z₂, and so on. The third digital data set X_{Z} 166 is an idealized representation of the first digital data set X 162 that a human operator 109 would understand to represent the first digital data set X 162 depicted in FIG. 9. Accordingly, inverting each subsequent layer of the AI model 900 in the reverse computational direction yields an increasingly idealized version of the original input to the AI model 900.

In some embodiments, the output of each layer during the inversion process in the reverse direction (see, e.g., FIG. 10) is an idealized representation of whatever digital data that layer received as in put in the forward direction (see, e.g., FIG. 9). For example, the second digital data set Y_{ZN-1} 1064M depicted in FIG. 10 is an idealized representation of the second digital data set Y_{N-1} 164 M depicted in FIG. 9. Referring to the second digital data set Y_{ZN-1} 1064M as an “idealized representation” of the second digital data set Y_{N-1} 164 M means that the second digital data set Y_{ZN-1} 1064M is understandable by a human operator 109 to represent the second digital data set Y_{N-1} 164 M. For example, upon perceiving the second digital data set Y_{ZN-1} 1064M the human operator 109 understands the second digital data set Y_{ZN-1} 1064M to represent the second digital data set Y_{N-1} 164 M. The second digital data set Y_{ZN-2} 1064L depicted in FIG. 10 is an idealized representation of the second digital data set Y_{N-2} 164L depicted in FIG. 9. The second digital data set Y_{Z2} 1064B depicted in FIG. 10 is an idealized representation of the second digital data set Y₂ 164B depicted in FIG. 9. The second digital data set Y_{Z1} 1064A depicted in FIG. 10 is an idealized representation of the second digital data set Y₁ 164A depicted in FIG. 9.

In some embodiments, an invertible AI model allows a human operator to directly visualize the abstraction process one layer at a time when the AI model is processing an input to the AI model in the forward computational direction. For example, the human user is able to use a computer that is executing the AI model, as well as an electronic display of the computer, to retrieve and visualize the input and the output of each layer of the AI model. In some embodiments, the invertible AI model also allows the human user to directly visualize the idealization process one layer at a time when the AI model is processing an output of the AI model in the reverse computational direction. For example, the human user is able to use a computer that is executing the AI model, as well as the electronic display, to retrieve and visualize the input and the output of each layer of the AI model. These features of the AI model make the functionality of each layer of the AI model more interpretable by the human user of the AI model.

Unit inversion is now described according to some embodiments. Just as the collective output of any layer can be inverted, so can an individual unit in the AI model be inverted. In some embodiments, the function of any given unit can be perceived by the human user of the AI model by setting its output value to one and the output value of all other units in the layer to zero, then inverting all the way back to the first layer of the AI model. This process is referred to as unit inversion. See, for example, the embodiment depicted in FIG. 10.

Interpretability Metric: Quantifying Interpretability Using Invertibility

In some embodiments, the certification system determines that an interpretability threshold is satisfied so long as the third digital data set X_{Z} 166 outputted by the AI model in a reverse computational direction is an idealized representation of the first digital data set X 162 that a human operator 109 would understand to represent the first digital data set X 162 inputted to the AI model in the forward computational direction.

In some embodiments, interpretability is a subjective measure because it is a measure of whether a human can interpret how the AI model is processing digital data and therefore assessing interpretability requires a human observer. However, invertibility is a measure of an ability of an AI model to reconstruct an idealized representation of an input to the AI model based solely on the output to the AI model. The following are some examples of processes executed by the certification system that use invertibility of an AI model to measure interpretability of the AI model according to some embodiments:
(1) for the AI model having one or more layers, the certification system (a) causes and observes the processing of AI model of an input to the AI model (e.g., the first digital data set X) through all of the layers of the AI model in the forward computational direction, then inverts the digital data back to the first layer of the AI model in the reverse computational direction and (b) queries a human user of the certification system to judge whether the inverted reconstruction (e.g., the third digital data set X_{Z}) is identifiable by the human user as an idealized version of the original input to the AI model (e.g., the first digital data set X);
(2) for each layer of the AI model, the certification system (a) causes and observes the processing of an input to the AI model (e.g., the first digital data set X) up through one or more layers of the AI model in the forward computational direction, then inverts the digital data back to the first layer of the AI model in the reverse computational direction and (b) queries a human user of the certification system to judge whether the inverted reconstruction (e.g., the third digital data set X_{Z}) is identifiable by the human user as an idealized version of the original input to the AI model (e.g., the first digital data set X);
(3) for a specific unit of an AI model (see, e.g., the units 620A, B . . . N depicted in FIG. 6, where the “N” indicates any positive whole number greater than one) being evaluated by the certification system, the certification system (a) activates that specific unit by itself and inverts its layer back to the first layer (i.e., unit inversion as described above) and (b) queries a human user to judge if this results in an identifiable feature; and
(4) for a specific unit of an AI model, the certification system (a) identifies a portion of an input to the AI model (e.g., the first digital data set X) in which that specific unit is strongly active (e.g., the unit is one whose pattern recognition assignment is relevant to the identified input to the AI model), (b) extracts only the portion of the input that the specific unit is attempting to describe (e.g., in an image recognition network, extract the spatial area of the image from which the unit is the receiving input); and (c) queries a human user to perform similar or different discriminations between pairs selected from this portion of the input and a control group of members of data (e.g., random portions of the input data) to determine if the human user agrees that the selected portions of the input which the specific unit is responding to are actually similar to one another.

In some embodiments, the certification system is configured to determine whether an AI model satisfies the interpretability metric over a randomly chosen subset of layers, units, and inputs for the AI model instead of determining interpretability for each available layer, unit, and input for the AI model.

Interpretability Metric: Input Enhancement Metric

In some embodiments, the certification system is operable to measure whether an AI model is able to provide input enhancement of digital data inputted to the AI model. If the certification system determines that the AI model satisfies both the robustness threshold and the interpretability threshold, then the AI model is (1) robust to corruption, (2) robust to distortion, and (3) invertible. Additionally, if the certification system determines that the AI model satisfies both the robustness metric and the invertibility metric, then the AI model is also able to enhance an input to the AI model (e.g., the first digital data set X) by processing the input with the first N layers of the AI model in the forward computational direction and then inverting back in the reverse computational direction to an idealized representation (e.g., the third digital data set X_{Z}) of the original input to the AI model. Due to the robustness of the AI model, the resulting idealized representation (e.g., the third digital data set X_{Z}) of the original input to the AI model is then free of corruption and distortion. Accordingly, an input to an AI model receives input enhancement if the input is (1) processed in the forward computational direction through at least one layer of the AI model and (2) processed in the reversed computational direction back to the first layer of the AI model to yield an idealized representation (e.g., the third digital data set X_{Z}) of the original input to the AI model that is free of corruption and distortion.

In some embodiments, the certification system determines whether an AI model satisfies an input enhancement threshold. The input enhancement threshold measures whether an AI model is able to provide input enhancement to an input to the AI model. In some embodiments, the certification system determines whether an AI model is able to provide input enhancement, and therefore satisfy the input enhancement threshold, by determining whether the AI model that satisfies both the robustness threshold and the invertibility threshold; if the AI model satisfies both of these thresholds, then the certification system determines that the AI model is also able to provide input enhancement, and so, the certification system determines that the AI model satisfies the input enhancement threshold.

Security Metric

The certification system includes code and routines that are operable to ensure that an AI model satisfies one or more of the following security thresholds as a condition to being certified by the certification system: (1) an adversarial attack security threshold; (2) a training data privacy threshold; and (3) a log security threshold.

Security Metric: Adversarial Attack Security Threshold

An adversarial attack is a malicious attempt to fool an AI model into making an incorrect decision using specially designed inputs. The adversarial attack security threshold measures an ability of an AI model to resist a set of known methods for an adversarial attack.

In some embodiments, the certification system includes code and routines that simulate one or more adversarial attacks and monitors the response of the AI model to these simulations. If the AI model resists the one or more adversarial attacks, then the certification system determines that the adversarial attack security threshold is satisfied.

In some embodiments, the certification system includes code and routines that are configured to simulate one or more of the following three example types of adversarial attacks.

First, the minimum possible modification is made to an input correctly processed by the AI model causing it to be incorrectly processed by the AI model. For example, an AI model configured to perform image recognition correctly identifies a gun, but an adversarial attack subtly modifies the image pixels so that the AI model then outputs the label toothbrush even though to a human the image remains that of a gun.

Second, a large modification is made to the AI model input without changing the output of the AI model, and the modification is designed to disguise the input as incoherent or random information unrecognizable to a human. For example, the correctly identified image of a stop sign is evolved into what appears to be a field of random pixel noise but is still identified by the AI model as a stop sign. This image could then be placed in a roadway, its intent hidden from humans but maliciously targeting car navigation systems.

Third, using either of the above two mechanisms, a specially designed distractor is inserted into the input that is designed to dominate the decision-making mechanism of the AI model and override the ability of the AI model to perceive any other input. An example includes a distractor pattern printed on a shirt to blind biometric recognition systems to the face of the person wearing the shirt.

One example metric for quantifying the success rate of the AI model at withstanding adversarial attacks is how often a correctly processed input can be modified to the point at which a human would disagree with the output of the AI model.

Security Metric: Training Data Privacy Threshold

A training data privacy attack includes an attack on the information included in the training data used to train an AI model. If the training data includes private information (e.g., images of faces, biometrics, medical records, etc.), there should be no way to recover individual records of the training data from a deployed AI model. For example, it should not be possible to extract an individual patient's medical records from either the parameters of the AI model itself or by examining the input/output behavior of the AI model, either of which are examples of a training data privacy attack.

In some embodiments, the certification system includes code and routines that simulate one or more training data privacy attacks and monitors the response of the AI model to these simulations. If the AI model resists the one or more training data privacy attacks, then the certification system determines that the adversarial attack security threshold is satisfied.

In some embodiments, to assess whether or not an invertible model has training data privacy violations, unit inversion (see description above) is used by the certification system to test whether any units of the AI models are based on individually identifiable input data. Ideally, the parameters of each unit are computed from a sufficiently aggregated group of input data examples so that it is not traceable to any individual example.

In some embodiments, one measure of whether an AI model satisfies the training data privacy threshold is how many unit inversions produce input reconstructions that are within a predefined minimum distance of an individual item in the training data. Beyond the privacy issues, scoring well on this test also ensures that the model is not memorizing individual training examples.

Security Metric: Log Security Threshold

An AI model includes digital logs that stores digital data describing information describing the operation of the AI model and/or other information used by the AI model or the human designer of the AI model. A log security attack includes an attack on the digital logs maintained by an AI model. For example, if the AI model logs information during deployment to audit and/or improve its future performance and this log contains sensitive information, it should be stored and transmitted securely by AI model.

In some embodiments, the certification system includes code and routines that simulate one or more log security attacks and monitors the response of the AI model to these simulations. If the AI model resists the one or more log security attacks, then the certification system determines that the adversarial attack security threshold is satisfied.

In some embodiments, a measure of whether an AI model satisfies a log security threshold includes the encryption level used by the AI model to: (1) secure the digital data stored in the digital logs of the AI model; and/or (2) transmit the digital data stored in the digital log. For example, in some embodiments, the log security threshold specifies a minimum encryption level for AI models and the certification system determines that the AI model satisfies the log security threshold if the encryption level for the digital log of the AI model satisfies the standard specified by the log security threshold.

In some embodiments, a secured log includes a security log generated by an AI model that satisfies the standard specified by the log security threshold. In some embodiments, the log security threshold is configured to verify that the AI model is sufficiently invertible to create a secured log that satisfies the log security threshold. In some embodiments, the certification system is operable verify that an AI model is sufficiently invertible to create a secured log that satisfies a threshold for its security (e.g., the log security threshold).

Efficiency Metric

AI models use computational resources that need to be taken into consideration when determining whether they are feasible to deploy and maintain in the real world. Accordingly, the certification system includes code and routines that are configured to determine whether an AI model satisfies an efficiency threshold as a condition for certifying the AI model. The efficiency threshold measures whether an AI model is efficient among one or more of the following performance categories: (1) training cost efficiency; (2) incremental training cost efficiency; (3) inference cost efficiency; (4) memory footprint efficiency; and (5) dependency efficiency.

The training cost efficiency of an AI model measured by the certification system when determining whether the efficiency threshold is satisfied includes the computational resources and the size of training set required to train the AI model from its first use. In some embodiments, the certification system includes code and routines that (1) measure the computational resources and the size of training set required to train the AI model from its first use and (2) compare this to the efficiency threshold to determine whether the efficiency threshold is satisfied by the performance of the AI model. The certification system determines that the efficiency threshold is satisfied if the computational resources and the size of training set required to train the AI model from its first use satisfy the efficiency threshold.

The incremental training cost efficiency of an AI model measured by the certification system when determining whether the efficiency threshold is satisfied includes the computational resources and number of training examples required to incrementally increase the capability of an AI model without retraining the AI model from scratch (e.g., adding a new object category to an image recognition model). In some embodiments, the certification system includes code and routines that (1) measure the computational resources and number of training examples required to incrementally increase the capability of an AI model without retraining the AI model from scratch and (2) compare this to the efficiency threshold to determine whether the efficiency threshold is satisfied by the performance of the AI model. The certification system determines that the efficiency threshold is satisfied if the computational resources and number of training examples required to incrementally increase the capability of an AI model without retraining the AI model from scratch satisfies the efficiency threshold.

The inference cost efficiency of an AI model measured by the certification system when determining whether the efficiency threshold is satisfied includes the statistical distribution of computational resources for the AI model to process a single input. In some embodiments, the certification system includes code and routines that (1) measure the statistical distribution of computational resources for the AI model to process a single input and (2) compare this to the efficiency threshold to determine whether the efficiency threshold is satisfied by the performance of the AI model. The certification system determines that the efficiency threshold is satisfied if the statistical distribution of computational resources for the AI model to process a single input satisfies the efficiency threshold.

The memory footprint efficiency of an AI model measured by the certification system when determining whether the efficiency threshold is satisfied includes the memory required to store the parameters of an AI model and the execution code of the AI model. In some embodiments, the certification system includes code and routines that (1) measure the memory required to store the parameters of an AI model and the execution code of the AI model and (2) compare this to the efficiency threshold to determine whether the efficiency threshold is satisfied by the architecture or design of the AI model. The certification system determines that the efficiency threshold is satisfied if the memory required to store the parameters of an AI model and the execution code of the AI model satisfies the efficiency threshold.

The dependency efficiency of an AI model measured by the certification system when determining whether the efficiency threshold is satisfied includes the resources required by any preprocessing or other AI models that are required to run as input to the AI model under consideration by the certification system (e.g., a birdsong recognition model may require the output from a general audio AI model). For example, a first AI model under consideration may require the use of a second AI model in order for the first AI model to function properly. In this example, the second AI model is a dependency of the first AI model, and so the resources required by the second AI model is also considered by the certification system when evaluating whether the architecture, design, and performance of the first AI model satisfy the efficiency threshold.

Threshold data includes digital data that describes any threshold described herein. An example of the threshold data includes the threshold data 169 depicted in FIG. 1.

Graphical user interface (GUI) data includes digital data that includes instructions that are sufficient to instruct an electronic display device of a computer system to display a graphical output. An electronic display device includes a computer monitor, a tablet computer, a projector, or any other electronic display device. For example, the GUI data includes digital data to cause the electronic display device to display information about whether an AI model has satisfied a set of thresholds sufficient to satisfy the RISE metrics and earn a certification from the certification system. In some embodiments, the GUI data includes digital data to cause the electronic display to display an interface of a digital store in which users can license one or more AI models from the digital store. In some embodiments, the GUI data includes digital data to cause the electronic display to display an interface of the digital store in which a human operator can purchase or license the certification for an AI model they have submitted for certification testing to the certification system.

An example of the GUI data according to some embodiments includes the GUI data 170 depicted in FIG. 1.

An example of the electronic display device according to some embodiments includes the electronic display device 149 depicted in FIG. 1.

Digital store data includes code and routines that describes a digital store in which users can purchase or license AI models from the operator of the digital store. For example, the digital store data describes one or more of the following: the interfaces of the digital store; the databases used to provide the functionality of the digital store; the encryption and security features provided by the digital store; the payment processing system of the digital; the user accounts of the digital store; the vendor accounts of the digital store; and any other information necessary to provide a digital store front in which users can purchase or license AI models from the digital store. In some embodiments, the digital store provides debugger tools in which human operators are able to debug AI models and ensure the interoperability among a plurality of AI models. An example of the digital store data according to some embodiments includes the digital store data 172 depicted in FIG. 1.

In some embodiments, the operator of the digital store is the same as the operator of the certification system. In some embodiments, human operators submit AI models to the digital store so that others can purchase or license the AI models from the digital store in exchange for a fee, which is then split between the human operators and the operator of the digital store.

In some embodiments, the digital store will only accept an AI model for sell or licensing in digital store if the AI model is certified by the certification system. In some embodiments, the certification system analyzes the AI model to determine whether the architecture and operation of the AI model satisfies a set of thresholds corresponding to the RISE metrics responsive to the human operator submitting the AI model to the digital store for approval.

Analysis data includes digital data that describes the analysis executed by the certification system to determine whether an AI model satisfies a set of thresholds for the RISE metrics. An example of the analysis data according to some embodiments includes the analysis data 168 depicted in FIG. 1.

Example General Method

In some embodiments, the certification system includes code and routines that are operable, when executed by a processor, to cause the processor to execute one or more steps of an example general method described herein.

The steps of the example general method are now described according to some embodiments.

Step 1: Analyzing the AI model to determine that the AI model is compliant with the set of metrics. Analysis data includes digital data that describes this analysis. The analysis includes one or more of the following sub-steps: (1) determining a set of RISE metrics for the AI model as described by the metrics data (the analysis of AI model having different functionality utilize different RISE metrics—for example, an AI model which performs image recognition might utilize different RISE metrics that an AI model that performs audio recognition); (2) determining a set of thresholds corresponding to RISE metrics for the AI model; (3) executing one or more tests to determine whether the architecture and/or operation of the AI model satisfy the set of thresholds; (4) determining which of the thresholds must be satisfied for the AI model to be “compliant with the set of metrics” (this threshold of compliance, or minimum compliance level, is described by the metrics data 195 and different AI models may trigger a different minimum compliance level based on their functionality); and (5) determining whether the outcome of the tests satisfies the minimum compliance level.

In some embodiments, the set of metrics includes verifying that at least one layer Z of the AI model is invertible. In some embodiments, the set of metrics includes verifying that each layer of the AI model is invertible.

Step 2: Certifying the AI model responsive to determining that the AI model is compliant with the set of metrics. In some embodiments, the AI model is certified responsive to determining that the AI model is compliant with the set of metrics that includes

Step 3: Issuing the certification to the human operator that submitted the AI model to the certification system for review. In some embodiments, an AI model that receives the certification of the certification system is approved for publication to the digital store so that others can view an advertisement for the AI model and choose to purchase or license the AI model from the digital store.

Example Operative Environment

Embodiments of the certification system are now described. Referring now to FIG. 1, depicted is a block diagram illustrating an operating environment 100 for a certification system 199 according to some embodiments.

The operating environment 100 may include one or more of the following elements: a computer system 123; a first human operator 109 of the computer system 123; a server 103; and a client 104; and a second human operator 110 of the client 104. One or more of the computer system 123, the server 103, and the client 104 are communicatively coupled to one another via a network 105. These elements of the operating environment 100 are depicted by way of illustration. In practice, the operating environment 100 may include one or more of the elements depicted in FIG. 1. For example, although only one computer system 123 is depicted in FIG. 1, in practice the operating environment 100 can include a plurality of these elements. The elements depicted in FIG. 1 with a dashed line are optional elements of the operating environment 100. For example, the following are optional elements of the operating environment 100: the network 105; the server 103; the client 104; and the second human operator 110.

The network 105 is a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices and/or entities may communicate. In some embodiments, the network 105 may include a peer-to-peer network. The network 105 may also be coupled to or may include portions of a telecommunications network for sending data in a variety of different communication protocols. In some embodiments, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, full-duplex wireless communication, mmWave, WiFi (infrastructure mode), WiFi (ad-hoc mode), visible light communication, TV white space communication and satellite communication. The network 105 may also include a mobile data network that may include 3G, 4G, 5G, millimeter wave (mmWave), LTE, LTE-D2D, VoLTE or any other mobile data network or combination of mobile data networks.

The computer system 123 includes a processor-based computing device. For example, the computer system 123 includes a computer, a server computer, a mainframe computer, a graphics card, or any other processor-based computing device. The computer system 123 includes one or more of the following elements: a processor 125; a communication unit 145; an interface device 129; the electronic display device 149; the certification system 199; and a memory 127. These elements are communicatively coupled to one another via a bus 121.

The processor 125 includes an arithmetic logic unit, a microprocessor, a general-purpose controller, or some other processor array to perform computations and provide electronic display signals to a display device. The processor 125 processes data signals and may include various computing architectures including a complex instruction set computer (CISC) architecture, a reduced instruction set computer (RISC) architecture, or an architecture implementing a combination of instruction sets. Although FIG. 1 depicts a single processor 125 present in the computer system 123, multiple processors may be included in the computer system 123. The processor 125 may include a graphical processing unit. Other processors, operating systems, sensors, displays, and physical configurations may be possible.

The communication unit 145 transmits and receives data to and from a network 105 or to another communication channel. In some embodiments, the certification system 199 is operable to control all or some of the operation of the communication unit 145.

In some embodiments, the communication unit 145 includes a port for direct physical connection to the network 105 or to another communication channel. For example, the communication unit 145 includes a USB, SD, CAT-5, or similar port for wired communication with the network 105. In some embodiments, the communication unit 145 includes a wireless transceiver for exchanging data with the network 105 or other communication channels using one or more wireless communication methods, including: IEEE 802.11; IEEE 802.16, BLUETOOTH®; and any derivative or analog thereof.

In some embodiments, the communication unit 145 includes a radio that is operable to transmit and receive electronic messages via the network 105. For example, the communication unit 145 includes a radio that is operable to transmit and receive any type of electronic communication described above for the network 105.

In some embodiments, the communication unit 145 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some embodiments, the communication unit 145 includes a wired port and a wireless transceiver. The communication unit 145 also provides other conventional connections to the network 105 for distribution of files or media objects using standard network protocols including TCP/IP, HTTP, HTTPS, and SMTP, millimeter wave, DSRC, etc.

The first human operator 109 includes a human user of the computer system 123. For example, the human operator is a human that operates or manages the computer system 123.

The second human operator 110 is a human user of the client 104. The client 104 includes a processor-based computing device similar to the computer system 123. For example, the client 104 includes one or more of the following: a laptop; a computer; a mainframe; a hardware server; a tablet computer; and any other processor-based computing device or combination of processor-based computing devices. In some embodiments, the client 104 includes elements similar to those depicted in FIG. 1 as being elements of the computer system 123. For example, in some embodiments the client 104 includes its own instances of one or more of the following elements which are depicted in FIG. 1 as elements of the computer system 123: a communication unit 145; a processor 125; an interface device 129; a memory 127 storing digital data such as the AI model 198 and training data 196; and an electronic display device 149. Accordingly, in some embodiments the operating environment 100 includes a computer system 123 and a client 104 and these elements of the operating environment 100 include similar elements with the exception being that the client 104 does not include a certification system 199 or digital store data 172.

In some embodiments, the second human operator 110 is a human that uses the client 104 to interface with the computer system 123 via the network 105. For example, the second human operator 110 is a designer of an AI model 198 that uploads the AI model 198 to the computer system 123 via the network 105 and submits the AI model 198 to testing by the certification system 199. In some embodiments, receiving certification from the certification system 199 is a prerequisite to the AI model being accepted as an item that is licensable via the digital store provided by one or more of the computer system 123 and the server 103.

An interface device 129 includes one or more electronic devices used by the first human operator 109 to interface with the computer system 123. For example, the interface device 129 includes one or more of the following: a keyboard; a mouse; a trackball; a stylus; a touchscreen; a microphone; a speaker; a digital assistant software program; and any other device usable by the human operator 109 to input information to the computer system 123 or receive information from the computer system 123. In some embodiments, the client 104 includes an interface device 129 that the second human operator 110 uses to interface with the client 104.

The electronic display device 149 includes an electronic display device used to view graphical data generated by a processor-based computing device. For example, the electronic display device 149 includes one or more of the following: a monitor; a touchscreen panel; an electronic screen; an e-ink display; a projector; and any other electronic display device. In some embodiments, the client 104 includes an electronic display device 149.

The memory 127 may include a non-transitory storage medium. The memory 127 may store instructions or data that may be executed by the processor 125. The instructions or data may include code for performing the techniques described herein. The memory 127 may be a dynamic random-access memory (DRAM) device, a static random-access memory (SRAM) device, flash memory, or some other memory device. In some embodiments, the memory 127 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some embodiments, the memory 127 may store any or all of the digital data or information described herein.

As depicted in FIG. 1, the memory 127 stores the following digital data: the first digital data set X 162; the second digital data set Y 164; the third digital data set X_{Z} 166; the analysis data 168; the threshold data 169; the GUI data 170; the digital store data 172 (optional); the training data 196; the metric data 195; and the AI model 198. The above-described elements of the memory 127 were described above, and so, those descriptions will not be repeated here.

In some embodiments, the training data 196 is stored in a memory of the client 104 and not the computer system 123.

The AI model 198 includes one or more layers 197. For example, an AI model 198 includes an first layer and one or more processing layers. An example of these layers is depicted in FIGS. 7, 9, and 10

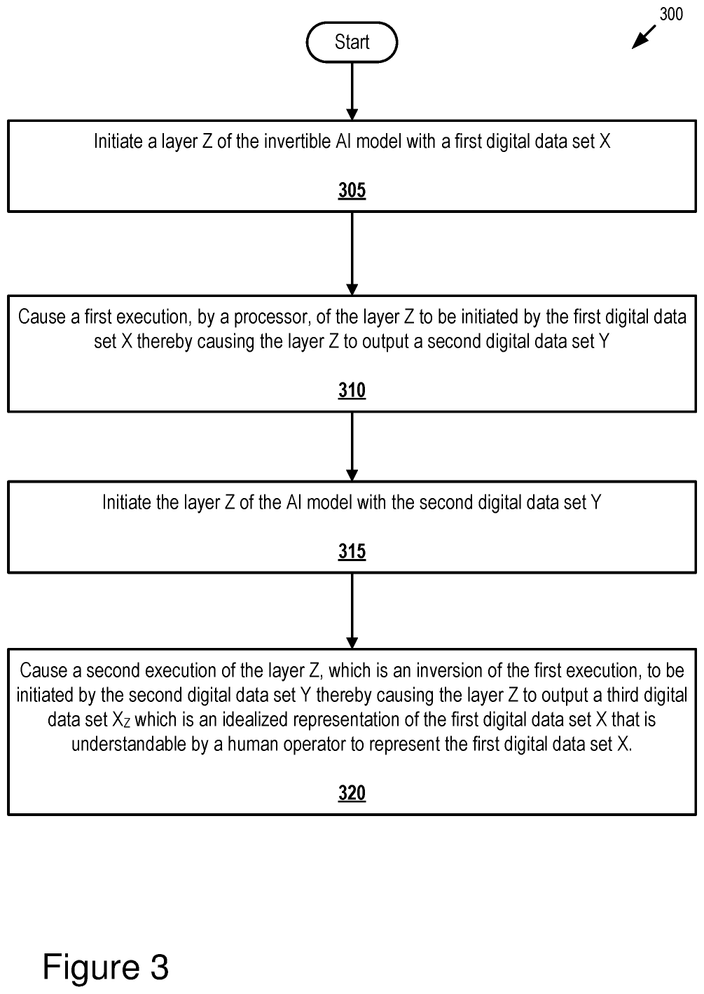

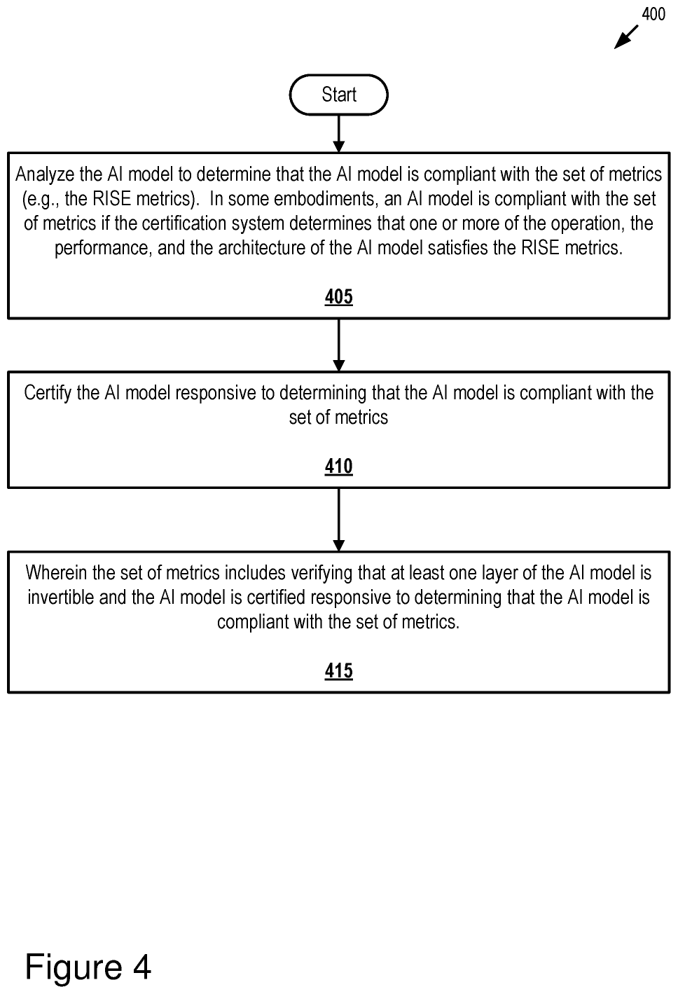

In some embodiments, the certification system 199 includes code and routines that are operable, when executed by the processor 125, to execute one or more steps of the example general method described herein. In some embodiments, the certification system 199 includes code and routines that are operable, when executed by the processor 125, to execute one or more steps of the method 300 described below with reference to FIG. 3. In some embodiments, the certification system 199 includes code and routines that are operable, when executed by the processor 125, to execute one or more steps of the method 400 described below with reference to FIG. 4.

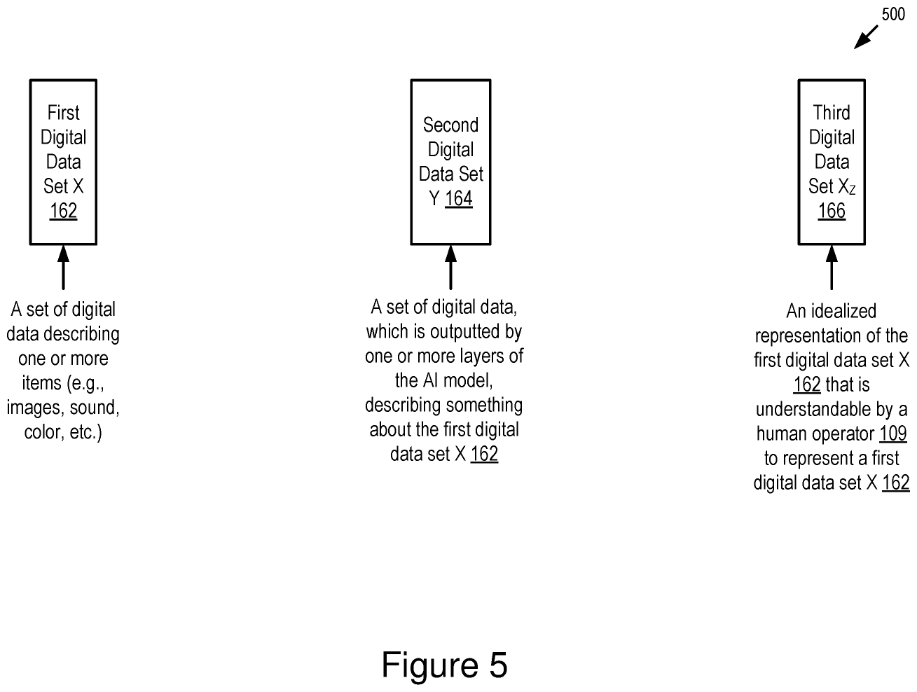

In some embodiments, the certification system 199 includes code and routines that are operable, when executed by the processor 125, to execute one or more steps of the of the methods, processes, and analyses described below with reference to FIGS. 5-10. In some embodiments, the certification system 199 includes code and routines that are operable, when executed by the processor 125, to execute any of the processes or analyses described herein.

In some embodiments, the certification system 199 includes code and routines that are operable, when executed by the processor 125, to cause the processor 125 to execute the digital store data 172 and provide a digital storefront as described herein.

In some embodiments, the certification system 199 is implemented using hardware including a field-programmable gate array (“FPGA”) or an application-specific integrated circuit (“ASIC”). In some other embodiments, the certification system 199 is implemented using a combination of hardware and software.

The server 103 includes a hardware processor-based computing device. For example, the server 103 includes a computer, a server computer, a mainframe computer, a graphics card, or any other processor-based computing device. In some embodiments, the server 103 includes a cloud server.

In some embodiments, the server 103 includes elements and functionality which are similar to those described above for the computer system 123, and so, those descriptions will not be repeated here. For example, in some embodiments the server 103 includes its own instances of one or more of the following elements which are depicted in FIG. 1 as elements of the computer system 123: a communication unit 145; a processor 125; an interface device 129; a memory 127 storing digital data such as any or all of the digital data depicted in FIG. 1 or otherwise described herein; and an electronic display device 149. Accordingly, in some embodiments the operating environment 100 includes a computer system 123 and a server 103 and these elements of the operating environment 100 include similar elements.

In some embodiments, the server 103 includes one or more of a digital store data 172 and a computer system 123. In some embodiments, the server 103 is responsible for hosting the digital store which is provided by the execution of the digital store data 172.

In some embodiments, the server 103 is operable to provide any other functionality described herein. For example, the cloud server 103 is operable to execute some or all of the steps of the methods described herein.

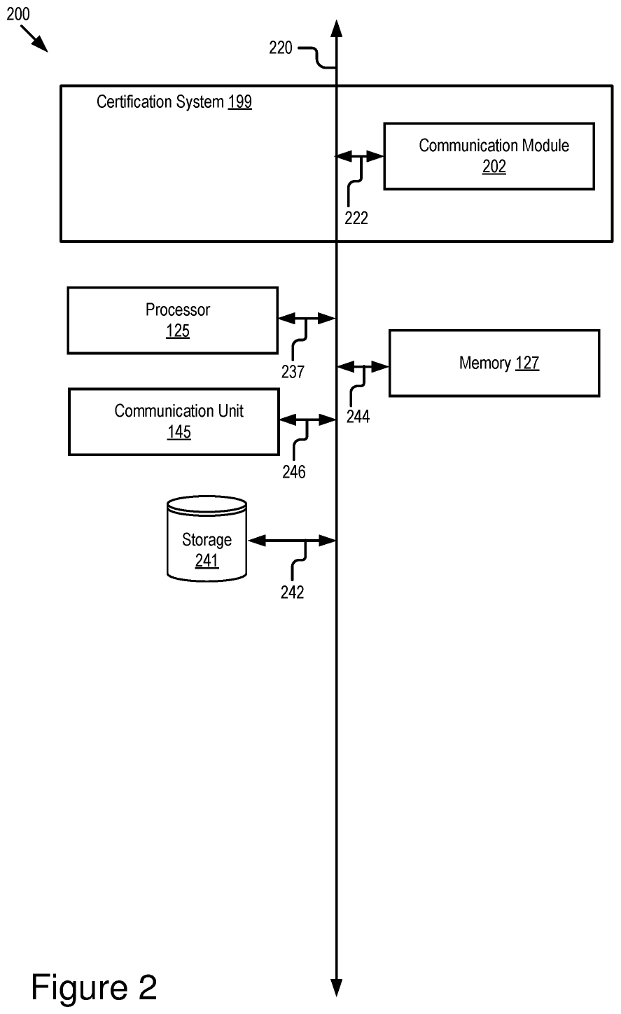

Referring now to FIG. 2, depicted is a block diagram illustrating an example computer system 200 including a certification system 199 according to some embodiments.

In some embodiments, the computer system 200 may include a special-purpose computer system that is programmed to perform one or more of the following: one or more steps of one or more of the method 300 described herein with reference to FIG. 3; one or more steps of one or more of the method 400 described herein with reference to FIG. 4; the methods, processes and/or analyses described herein with reference to FIGS. 5-10; and the example general method described herein.

In some embodiments, the computer system 200 includes a processor-based computing device. For example, the computer system 200 includes a cloud server.

The computer system 200 may include one or more of the following elements according to some examples: the certification system 199; a processor 125; a communication unit 145; a storage 241; and a memory 127. The components of the computer system 200 are communicatively coupled by a bus 220.

In some embodiments, the computer system 200 includes additional elements such as those depicted in FIG. 1 as elements of the certification system 199.

In the illustrated embodiment, the processor 125 is communicatively coupled to the bus 220 via a signal line 237. The communication unit 145 is communicatively coupled to the bus 220 via a signal line 246. The storage 241 is communicatively coupled to the bus 220 via a signal line 242. The memory 127 is communicatively coupled to the bus 220 via a signal line 244.

The following elements of the computer system 200 were described above with reference to FIG. 1, and so, these descriptions will not be repeated here: the processor 125; the communication unit 145; and the memory 127.

The storage 241 includes a non-transitory storage medium that stores data for providing the functionality described herein. The storage 241 may be a DRAM device, a SRAM device, flash memory, or some other memory devices. In some embodiments, the storage 241 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some embodiments, the certification system 199 includes code and routines that are operable, when executed by the processor 125, to cause the processor 125 to execute one or more steps of the method 300 described herein with reference to FIG. 3. In some embodiments, the certification system 199 includes code and routines that are operable, when executed by the processor 125, to cause the processor 125 to execute one or more steps of the method 400 described herein with reference to FIG. 4. In some embodiments, the certification system 199 includes code and routines that are operable, when executed by the processor 125, to cause the processor 125 to execute one or more steps of the example general method. In some embodiments, the certification system 199 includes code and routines that are operable, when executed by the processor 125, to cause the processor 125 to execute one or more of the methods, processes, and/or analyses described below with reference to FIGS. 5-10.

In the illustrated embodiment shown in FIG. 2, the certification system 199 includes a communication module 202.

The communication module 202 can be software including routines for handling communications between the certification system 199 and other components of the computer system 200. In some embodiments, the communication module 202 can be a set of instructions executable by the processor 125 to provide the functionality described below for handling communications between the certification system 199 and other components of the computer system 200. In some embodiments, the communication module 202 can be stored in the memory 127 of the computer system 200 and can be accessible and executable by the processor 125. The communication module 202 may be adapted for cooperation and communication with the processor 125 and other components of the computer system 200 via signal line 222.

The communication module 202 sends and receives data, via the communication unit 145, to and from one or more elements of the operating environment 100.

In some embodiments, the communication module 202 receives data from components of the certification system 199 and stores the data in one or more of the storage 241 and the memory 127.

In some embodiments, the communication module 202 may handle communications between components of the certification system 199 or the computer system 200.

In some embodiments, the certification system 199 is operable to generate and output a report card that describes scores for how well an AI model satisfies different thresholds. So for example, two AI models A and B may both pass all of the thresholds tested by the certification system 199 but AI model A may have a better open set recognition score. This fact is reflected in the report cards for the two AI models A and B. A shopper in the digital store can view the report cards prior to making purchases. The shopper may use the report cards to decide whether to purchase a license for AI model A over AI model B. In some embodiments, the price for licensing AI model A is higher than AI model A because it has increased capability relative to AI model A.

Referring now to FIG. 3, depicted is a flowchart of an example method 300 according to some embodiments. The method 300 includes step 305, step 310, step 315, and step 320 as depicted in FIG. 3. The steps of the method 300 may be executed in any order, and not necessarily those depicted in FIG. 3. In some embodiments, one or more of the steps are skipped or modified in ways that are described herein or known or otherwise determinable by those having ordinary skill in the art.

Referring now to FIG. 4, depicted is a flowchart of an example method 400 according to some embodiments. The method 400 includes step 405, step 410, and step 415, step as depicted in FIG. 4. The steps of the method 400 may be executed in any order, and not necessarily those depicted in FIG. 4. In some embodiments, one or more of the steps are skipped or modified in ways that are described herein or known or otherwise determinable by those having ordinary skill in the art.

Referring now to FIG. 5, depicted is a block diagram 500 illustrating the first digital data set X 162, the second digital data set Y 164, and the third digital data set X_{Z} 166 according to some embodiments.

The first digital data set X 162 includes a set of digital data describing one or more items. For example, the first digital data set X 162 includes digital data that describes one or more of the following: a set of images; a set of sounds; a set of colored pixels (of one or more colors); and any other digital data. In some embodiments, the first digital data set X 162 describes any digital data in which a pattern is recognizable by an AI model. In some embodiments, the AI model is one which is being tested by the certification system as part of a certification process. In some embodiments, the first digital data set X 162 is inputted to the AI model by the certification system as part of one or more tests being executed by the certification system.

The second digital data set Y 164 includes a set of digital data describing a set of digital data which is outputted by one or more layers of an AI model. For example, the first digital data set X 162 is inputted to an AI model. The AI model analyzes the first digital data set X 162 in a forward computational direction and outputs the second digital data set Y 164. The second digital data set Y 164 describes something about the first digital data set X 162.

In some embodiments, the AI model is required to be invertible in order to be certified by the certification system. The AI model receives the first digital data set X 162 in a forward computational direction as an input and outputs the second digital data set Y 164 in the forward computational direction. To be invertible, the AI model must be able to receive the second digital data set Y 164 in the reverse computational direction and output the third digital data set X_{Z} 166 in the reverse computational direction. The third digital data set X_{Z} 166 includes digital data that describes an idealized representation of the first digital data set X 162 that is understandable by a human operator to represent the first digital data set X 162.

Referring now to FIG. 6, depicted is a block diagram 600 illustrating the computational units of an AI model 198 according to some embodiments. The AI model 198 includes a plurality of processing layers. The plurality of processing layers includes a layer Z 610 . . . and a layer Z_{P} 615, where the ellipses indicates that the plurality includes any positive whole number of processing layers greater than one. The other ellipses depicted in FIG. 6 have similar meaning. For example, the first digital data set X 162 includes a plurality of digital data where the ellipses here indicates that the plurality includes a positive whole number of digital data greater than one.

As depicted, the first digital data set X 162 includes a plurality of digital data. The second digital data set Y 164 is depicted as including a plurality of digital data. The AI model 198 is depicted as including a plurality of layers Z. For example, the AI model 198 includes the following layers: a layer Z 610; and a layer Z_{P} where “P” indicates a plurality of layers are included in the AI model 198. In some embodiments, the AI model 198 includes two or more layers. A layer Z of an AI model 198 is a portion of the code and routines of the AI model 198 that is responsible for providing a discreet function that is predetermined based on the instructions included in the code and routines.

A layer of the AI model 198 includes a plurality of units 620A, 620B . . . 620N (where “N” indicates a positive whole number greater than two). In some embodiments, the AI model 198 includes at least two units 620. A unit 620 is a portion of the code and routines of the AI model 198 that is responsible for providing a discreet function that is predetermined based on the instructions included in the code and routines. For example, the layer that includes the units is designated to provide a particular function, and the units with the layer provide designated functionality that contributes the layer providing the particular function designated to the layer.

In some embodiments, the human operator 109 interface with the AI model 198 using one or more interface devices 129. In some embodiments, the AI model 198 is an element of a computer system 123 that is operating the certification system 199 and the human operator 109 is using the certification system 199 to test the performance of the AI model 198 to determine whether the AI model 198 is eligible for certification by the certification system 199.

Set of Thresholds

The certification system 199 executes a plurality of tests to determine whether the AI model 198 is compliant with a set of metrics (e.g., the RISE metrics). In some embodiments, an AI model 198 is compliant with the set of metrics if the certification system 199 determines that one or more of the operation, the performance, and the architecture of the AI model 198 satisfies the RISE metrics. The certification system 199 determines whether the AI model 198 satisfies the RISE metrics by determining whether one or more of the operation, the performance, and the architecture of the AI model 198 satisfies a set of thresholds. The set of thresholds includes one or more of the following thresholds:
one or more accuracy thresholds that measure a classification accuracy and/or an inference accuracy of the AI model 198;
one or more robustness thresholds that measure the robustness of the AI model 198 (e.g., one or more of the following: one or more adaptability thresholds that measure an adaptability of the AI model 198; one or more open set recognition thresholds that measure an ability of the AI model 198 to recognize data inputs outside of the training data used to train the AI model; and one or more runtime learning thresholds that measures an ability of the AI model 198 to learn new categories of inputs on the fly);
one or more interpretability thresholds that measure the invertibility of the AI model 198;
one or more input enhancement thresholds that measure the ability of the AI model 198 to enhance one or more inputs to the AI model 198;
one or more security thresholds that measure the resistance of the AI model 198 to one or more security threats (e.g., one or more of the following security thresholds: (1) an adversarial attack security threshold; (2) a training data privacy threshold; and (3) a log security threshold); and
one or more efficiency thresholds that measure whether an AI model 198 is efficient among one or more of the following performance categories: (1) training cost efficiency; (2) incremental training cost efficiency; (3) inference cost efficiency; (4) memory footprint efficiency; and (5) dependency efficiency.

Referring now to FIG. 7, depicted is a block diagram illustrating a forward computational direction of an operation 700 of a layer Z 705 of an AI model according to some embodiments. As depicted, the layer Z 705 of the AI model 799 includes a set of units: a first unit 710; and a second unit 715. As depicted, the units 710, 715 of the layer Z 705 receive digital data when inputted to the AI model 799.

In the embodiment depicted in FIG. 7, the first digital data set X 162 includes the following digital data: data 720; data 725; data 730; data 735; and data 740. As depicted, the first unit 710 receives the following inputs: the data 720; the data 725; and the data 730. Also as depicted, the second unit 715 receives the following inputs: the data 730; the data 735; and the data 740.

In the embodiment depicted in FIG. 7, the AI model 799 generates the second digital data set Y 164 based on the first digital data set X 162. The second digital data set Y 164 includes the following digital data: data 750; data 755; data 760; and data 765. As depicted, the first unit 710 outputs the data 750 based on the inputs it receives and the second unit 715 outputs the data 755 based on the input it receives. Data 760 and data 765 are outputted by one or more other layers of the AI model 799 that are not depicted in FIG. 7.

Referring now to FIG. 8, depicted is a block diagram illustrating a reverse computational direction of an operation 800 of the layer Z 705 of an AI model according to some embodiments. For example, FIG. 8 depicts an operation 800 in the reverse computational direction using a subset Xₛ of the output of the operation 700 depicted in FIG. 7.

The operation 800 is executed using a subset Xₛ of the second digital data set Y 164 is through the layer Z 705 of the AI model 799 in the reverse computational direction. As depicted in FIG. 8 the subset Xₛ includes the data 750. The output of this operation 800 is the third digital data set X_{z} 166. The third digital data set X_{z} 166 is an idealized representation of the first digital data set X 162 depicted in FIG. 7. In some embodiments, the third digital data set X_{z} 166 is understandable by the human operator 109 (e.g., when viewing the third digital data set X_{z} 166 using an electronic display device 149) to represent the first digital data set X 162 (e.g., the first digital data set X 162 depicted in FIG. 7).

The third digital data set X_{z} 166 includes a plurality of digital data. For example, as depicted in FIG. 8 the third digital data set X_{z} 166 includes: data 820; data 825; data 830; data 835; and data 840. Data 820, 825, and 830 are outputted by the unit 710 based on the data 750 as an input. The data 835 and 840 are generated by one or more other units (e.g., unit 715 is capable of generating both of data 835 and 840) based on other digital data (e.g., one or more of data 755, 760, 765).

Considered together, FIGS. 9 and 10 depict an example of how an AI model is interpretable by a human operator when the operation of the different layers of the AI model are invertible. Referring now to FIG. 9, depicted is a block diagram illustrating a forward computational direction of an operation 900 of a plurality of layers of an AI model 900 according to some embodiments.

The AI model 900 includes a plurality of layers Z_{P}: a first layer Z₁; a second layer Z₂; . . . a preceding Layer Z_{N-1} in the series; and an Nth layer Z_{N}. The ellipses “ . . . ” depicted in FIG. 9 indicates that the AI model 900 includes more than the fiver layers depicted in FIG. 9.

As depicted in FIG. 9, the first digital data set X 162 is inputted to the first layer Z₁ of the AI model. The output of the first layer Z₁ is the second digital data set Y 164A which is inputted to the second layer Z₂. The output of the second layer Z₂ is the second digital data set Y 164B which is inputted to a second layer Z which is not depicted in FIG. 9. The input to the preceding layer Z_{N-1} in the series is the second digital data set Y_{N-2} 164L. The output of the preceding layer Z_{N-1} in the series is the second digital data set Y_{N-1} 164 M which is input to the Nth layer Z_{N}. The output of the Nth layer Z_{N} is the second digital data set Y_{N} 164N.

A human operator 109 of a computer system 123 is able to use an electronic display device 149 and/or an interface device 129 to retrieve any of the inputs and/or any of the outputs described above and depicted in FIG. 9. In this way, the human operator 109 is able to consider the functionality of each of the layers Z of the AI model 900 since the input and the output of any of the layers Z is retrievable by the human operator 109. In this way, the functionality of the layers Z of the AI model 900 is interpretable by the human operator 109. The ability to invert the operation 1000 of these layers Z in the reverse computational direction provides increased insight into the functionality of the layers Z of the AI model 900.

Referring now to FIG. 10, depicted is a block diagram illustrating a reverse computational direction of an operation 1000 of a plurality of layers of the AI model 900 according to some embodiments.

As depicted in FIG. 10, the second digital data set Y_{N} 164N is inputted to the Nth layer Z_{N}. The output of the Nth layer Z_{N} is the second digital data set Y_{ZN-1} 1064M which is then inputted to the preceding layer Z_{N-1} in the series. The second digital data set Y_{ZN-1} 1064M is an idealized representation of the second digital data set Y_{N-1} 164 M that is depicted in FIG. 9. The output of the preceding layer Z_{N-1} in the series is the second digital data set Y_{ZN-2} 1064L (an idealized representation of the second digital data set Y_{N-2} 164L that is depicted in FIG. 9) which is inputted to a layer which is not depicted in FIG. 10. The input to the second layer Z₂ is the second digital data set Y_{z2} 1064B (an idealized representation of the second digital data set Y₂ 164B depicted in FIG. 9). The output of the second layer Z₂ is the second digital data set Y_{Z1} 1064A (an idealized representation of the second digital data set Y 164A depicted in FIG. 9) which is inputted to the first layer Z₁. The output of the first layer Z₁ is the third digital data set X_{Z} 166 which is outputted for storage in a memory 127 of the computer system 123. The third digital data set X_{Z} 166 is an idealized representation of the first digital data set X 162. The certification system 199 includes code and routines that retrieve the third digital data set X_{Z} 166 and generate GUI data that causes the electronic display of the computer system 123 to display the third digital data set X_{Z} 166 so that a human operator 109 can observe the third digital data set X_{Z} 166 and determine that it is understandable by the human operator 109 to represent the first digital data set X 162 depicted in FIG. 9.

Moreover, the human operator 109 of a computer system 123 is able to use the electronic display device 149 and/or the interface device 129 of the computer system 123 to retrieve any of the inputs and/or any of the outputs described above and depicted in FIG. 10. In this way, the human operator 109 is able to consider the functionality of each of the layers Z of the AI model 900 since the input and the output of any of the layers Z is retrievable by the human operator 109. The certification system 199 includes code and routines that enable the human operator 109 to execute one or more of the operations depicted in FIGS. 9 and 10 layer-by-layer through the AI model 900 and retrieve the inputs and the outputs at each layer in the operation.

In this way, the functionality of the layers Z of the AI model 900 are interpretable by the human operator 109 since the human operator 109 is able to retrieve and see (e.g., using the electronic display device 149) the inputs and the outputs of each individual layer Z of the AI model 900 in both the forward and the reverse computational directions, and thus understand how each layer modifies its inputs to generate its outputs in both the forward and the reverse computational directions. This is an example of what is meant by the AI model being “interpretable.” Thus, the AI model 900 is interpretable because it is invertible on a layer-by-layer basis. In some embodiments, an AI model is only certified by the certification system 199 if the AI model possesses the ability to function in this manner when tested by the certification system 199.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present embodiments can be described above primarily with reference to user interfaces and particular hardware. However, the present embodiments can apply to any type of computer system that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions that follow are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present embodiments of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some preferred embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A certification system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited, to keyboards, displays, pointing devices, etc.) can be coupled to the system either directly or through intervening I/O controllers.

Network adapters may also be coupled to the system to enable the certification system to become coupled to other certification systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method for providing an invertible Artificial Intelligence (AI) model, the method comprising:
initiating a layer Z of the invertible AI model with a first digital data set X;
causing a first execution, by a processor, of the layer Z to be initiated by the first digital data set X thereby causing the layer Z to output a second digital data set Y;
initiating the layer Z of the AI model with the second digital data set Y; and
causing a second execution of the layer Z, which is an inversion of the first execution, to be initiated by the second digital data set Y thereby causing the layer Z to output a third digital data set X_{Z} which is an idealized representation of the first digital data set X that is understandable by a human operator to represent the first digital data set X.

2. The method of claim 1, wherein the idealized representation is configured to allow the human operator to see how the layer Z is idealizing the first data set X.

3. The method of claim 1, wherein the idealized representation is configured to allow the human operator to see if the layer Z is making an interpretation error.

4. The method of claim 3, wherein the interpretation error includes a semantic miscategorization error.

5. The method of claim 1, wherein the second execution of the layer Z is initiated with a subset of the second digital data set Y and the third digital data set X_{Z} is configured to allow the human to understand what part of the first digital data set X is represented by the subset used to initiate the layer Z for the second execution.

6. The method of claim 5, wherein the subset is a single bit of data of the second digital data set Y.

7. The method of claim 1, wherein the second digital data set Y informs a human operator when the first digital data set X is not represented by any similar set of items within a training data set used to train the invertible AI model.

8. The method of claim 7, wherein the invertible AI model satisfies a threshold that measures how successfully the AI model informs the human operator about when the first digital data set X is not represented by any similar set of items within a training data set used to train the invertible AI model.

9. The method of claim 1, wherein the second digital data set Y includes an indication that the layer Z is unable to semantically categorize the first digital data set X because the first digital data set X is not represented by any similar set of items within a training data set used to train the invertible AI model.

10. The method of claim 1, wherein: the layer Z is invertible because the third digital data set X_{Z} is the idealized representation of the first digital data set X that is understandable by the human to represent the first digital data set X; the invertible AI model includes plurality of layers; and each of the layers is invertible.

11. The method of claim 1 wherein the method is modified to determine a functionality of the layer Z, the modifications to the method including:
the initiating the layer Z with the first digital data set X does not occur;
the first execution does not occur;
the layer Z includes a set of units U which includes a code set;
the units U are configured invertibly with a forward computational direction and a reverse computational direction, wherein being configured invertibly includes the units U being operable to
(1) receive in the forward computational direction the first digital data set X as inputs to the units U to generate the second digital data set Y as a forward output of the code set, the second digital data set Y including a subset Yₛ that is a specific output of a selected unit Us from the set of units U and
(2) receive in the reverse computational direction the second digital data set Y as inputs to the units U to generate the first digital data set X as a reverse output of the units U, the reverse output including a subset Xₛ of the first digital data set X that corresponds to the subset Yₛ and was outputted by the selected unit Uₛ in the reverse computational direction;
the subset Yₛ corresponding to the selected unit Us is set to an active value and other subsets of Y are set to an inactive value; and
the second execution occurs in the reverse computational direction to generate the subset Xₛ so that the human can interpret the functionality of the selected unit Us in a context of the first digital data set X.

12. The method of claim 11, wherein the invertible AI model includes a plurality of layers Z, wherein:
the layers Z included in the plurality are communicatively coupled in a series so that the layers Z receive, as an input, the output of a preceding layer in the series; and
wherein the plurality of layers Z are invertibly configured so that the first digital data set X is operable to be passed through the plurality of layers Z and the functionality of any of the layers Z included in the plurality is determinable using at least two applications of the method of claim 11.

13. A method for certifying that an Artificial Intelligence (AI) model is compliant with a set of metrics, the method comprising:
analyzing the AI model to determine that the AI model is compliant with the set of metrics; and
certifying the AI model responsive to determining that the AI model is compliant with the set of metrics; and
wherein the set of metrics includes verifying that at least one layer Z of the AI model is invertible and the AI model is certified responsive to determining that the AI model is compliant with the set of metrics.

14. The method of claim 13, wherein the set of metrics includes verifying that each layer Z of the AI model is invertible, wherein the AI model includes a plurality of layers Zₚ.

15. The method of claim 13, wherein the set of metrics further includes verifying an inference accuracy of the AI model by determining that execution of the AI model satisfies an accuracy threshold.

16. The method of claim 13, wherein the set of metrics further includes verifying an adaptability of the AI model by determining that execution of the AI model satisfies an adaptability threshold.

17. The method of claim 13, wherein the set of metrics further includes verifying an open set recognition of the AI model by determining that execution the AI model is able to identify when an input to the AI model is not represented by any similar items within a training data set used to train the AI model.

18. The method of claim 13, wherein the set of metrics further includes verifying a runtime learning ability of the AI model by determining that the AI model is able to learn new data categories in an unsupervised manner sufficient to satisfy a runtime learning threshold.

19. The method of claim 13, wherein the set of metrics further includes verifying that the AI model is sufficiently resistant to an adversarial attack by determining that execution of the AI model satisfies a threshold for resistance to the adversarial attack.

20. The method of claim 13, wherein the set of metrics further includes verifying that execution of the AI model is sufficiently resistant to leaking private information to satisfy a threshold for privacy.

21. The method of claim 13, wherein the set of metrics further includes verifying that the AI model is sufficiently invertible to create a secured log that satisfies a threshold for its security.

22. The method of claim 13, wherein the set of metrics further includes verifying an efficiency of the AI model by determining that execution the AI model satisfies one or more thresholds for efficiency.

23. The method of claim 22, wherein the one or more thresholds for efficiency are selected from a group that includes: a training cost threshold; an incremental training cost threshold; an inference cost threshold; and a memory footprint threshold.

24. The method of claim 13, further comprising issuing an indication of the certification.

25. The method of claim 13, further comprising providing a proof of the certification that is issued by an electronic store.

26. The method of claim 13, further comprising completing a financial transaction with an electronic store to license an indication of the certification.

27. The method of claim 13, further comprising publishing the AI model in an electronic store.

28. The method of claim 27, wherein a price of licensing the AI model from the electronic store is dependent at least in part on a performance of the AI model relative to a metric.

29. The method of claim 27, further comprising unpublishing the AI model from an electronic store responsive to determining that the AI model no longer satisfies the set of metrics.

30. The method of claim 13, further comprising completing a financial transaction to license the AI model via an electronic store.

31. The method of claim 13, further comprising issuing a certification that the AI model is validated as being compliant with the set of metrics.

32. A system for verifying that an Artificial Intelligence (AI) model is compliant with a set of metrics, the system comprising:
a processor;
a non-transitory memory that is communicatively coupled to the processor, wherein the non-transitory memory stores computer executable code that is operable, when executed by the processor, to cause the processor to execute operations including:
analyzing the AI model to determine that the AI model is compliant with the set of metrics; and
publishing the AI model responsive to determining that the AI model is compliant with the set of metrics; and
wherein the set of metrics includes verifying that at least one layer Z of the AI model is invertible.

33. A computer program product including computer code stored on a non-transitory memory that is operable, when executed by a computer, to cause the computer to execute operations including:
analyzing the AI model to determine that the AI model is compliant with a set of metrics; and
publishing the AI model responsive to determining that the AI model is compliant with the set of metrics; and
wherein the set of metrics includes verifying that at least one layer Z of the AI model is invertible.
